(19) United States
(12) Patent Application Publication
(10) Pub. No.: US 2007/0056200 A1
(43) Pub. Date: Mar. 15, 2007

(54) GRAPHICS INSTALLATION SYSTEM

(76) Inventor: Hank Brian Ridless, Boulder, CO (US)

Correspondence Address: ADAMS EVANS P.A., 301 SOUTH TRYON STREET, SUITE 2180, TWO WACHOVIA CENTER, CHARLOTTE, NC, 28282-1991, US

(21) Appl. No.: 11/531,918

(22) Filed: Sep. 14, 2006

Related U.S. Application Data
(60) Provisional application No. 60/596,302, filed on Sep. 14, 2005.
(60) Provisional application No. 60/597,104, filed on Nov. 10, 2005.
(60) Provisional application No. 60/597,895, filed on Dec. 22, 2005.
(60) Provisional application No. 60/597,896, filed on Dec. 22, 2005.
(60) Provisional application No. 60/766,707, filed on Feb. 7, 2006.

(51) Int. Cl. G09F 17/00

(52) U.S. Cl. 40/603

(57) ABSTRACT

A graphics installation system includes a sheet-like substrate adapted to display graphics disposed thereon and a supporting structure having a face for receiving the substrate. The substrate is positioned in a tensioned condition in front of the face, for example with clamp bars, resiliently-mounted hooks, or tensioned cables.

### BACKGROUND OF THE INVENTION

This invention relates generally to advertising displays and more particularly to a graphics installation system and substrate for outdoor advertisements.

Many types of outdoor displays are too large to be economically produced as a single unit, and therefore must be separated into smaller sections. For example, roadside billboards are commonly created by assembling multiple panels side-by-side and one-over-another on a supporting surface to collectively define a display. The panels are attached to the face of the supporting surface with an adhesive.

While such prior art methods are effective in creating large displays, the use of adhesive is inconvenient and time consuming for both application and removal, and requires skill to align the individual panels. Furthermore, the use of adhesive mounting limits the practical maximum size of the panels and therefore requires more individual panels to be installed for a given size of display.

It is desirable to produce such displays as single units in order to reduce the time and effort required for both application and removal. However, when such displays are made in large sizes they must meet certain strength requirements, which leads to high weights.

### BRIEF SUMMARY OF THE INVENTION

Accordingly, it is an object of the invention to provide a mounting system for lightweight graphics which does not use adhesives.

It is another object of the invention to provide a lightweight graphics substrate.

These and other objects are met by the present invention, which according to one aspect provides a graphics installation system, including: a sheet-like substrate adapted to display graphics disposed thereon; a supporting structure having a face for receiving the substrate; and a pair of spaced-apart clamp assemblies engaging opposed edges of the substrate and positioning the substrate in a tensioned condition in front of the face.

According to another aspect of the invention, each of the clamp assemblies includes a pair of elongated clamp bars adapted to grip an edge of the substrate therebetween; and a resilient element connecting the clamp bars to the supporting structure.

According to another aspect of the invention, the clamp bars are attached to the substrate by resilient, generally U-shaped clips.

According to another aspect of the invention, the clamp bars are attached to a surface of the substrate by an adhesive.

According to another aspect of the invention, each of the clamp assemblies includes: an elongated first bar adapted to be connected to an edge of the substrate; an elongated second bar adapted to be connected to the supporting structure; and a resilient element connecting the first and second bars.

According to another aspect of the invention, a graphics installation system includes: a sheet-like substrate adapted to display graphics disposed thereon; a supporting structure having a face for receiving the substrate; a pair of spaced-apart clamp assemblies engaging opposed edges of the substrate; and a pair of spaced-apart cable assemblies connected to respective ones of the clamp assemblies, the cable assemblies extending substantially parallel to respective edges of the substrate and arranged so as to position the substrate in a tensioned condition in front of the face.

According to another aspect of the invention, each of the cable assemblies includes a cable having a first end anchored to the supporting structure and a second end connected to a winch for tensioning the cable.

According to another aspect of the invention, each of the clamp assemblies includes a pair of elongated clamp bars adapted to grip an edge of the substrate therebetween; and a resilient element connecting the clamp bars to the supporting structure.

According to another aspect of the invention, the clamp bars are attached to the substrate by resilient, generally U-shaped clips.

According to another aspect of the invention, a graphics installation system includes: a sheet-like substrate having at least one pair of opposed edges, the substrate adapted to display graphics disposed thereon; a pair of rigid bars carried by the substrate extending along the respective opposed edges; a supporting structure having a face for receiving the substrate; and a plurality of resilient mounts carried by the substrate and engaging the rigid bars so as to position the substrate in a tensioned condition in front of the face.

According to another aspect of the invention, each of the rigid bars is carried in a pocket defined by a reinforcing strips applied to the substrate along an edge thereof.

According to another aspect of the invention, each of the rigid bars is carried in a pocket defined by a reinforcing strips applied to the substrate along an edge thereof.

According to another aspect of the invention, each of the rigid bars is carried in a pocket defined by a reinforcing strip applied to the substrate along an edge thereof.

According to another aspect of the invention, a graphics installation system includes: a sheet-like substrate having at least one pair of opposed edges, the substrate adapted to display graphics disposed thereon; a pair of rigid bars carried by the substrate extending along the respective opposed edges; a supporting structure having a face for receiving the substrate; and a plurality of resilient mounts carried by the substrate and engaging the rigid bars so as to position the substrate in a tensioned condition in front of the face.

According to another aspect of the invention, a graphics installation system includes: a sheet-like substrate adapted to display graphics disposed thereon; a perimeter frame attached to the substrate of rigid bars carried by the substrate extending along the respective opposed edges; a supporting structure having a face for receiving the substrate; and a plurality of resilient mounts carried by the supporting structure and engaging the rigid bars so as to position the substrate in a tensioned condition in front of the face.

According to another aspect of the invention, a graphics installation system includes: a flexible, sheet-like substrate adapted to display graphics disposed thereon; and a frame comprising a plurality of relatively rigid elongated members attached to a face of the substrate near its perimeter, so at to retain the substrate in a substantially flat, tensioned condition.

According to another aspect of the invention, adjacent ones of the frame members are connected to each other with flexible hinges so as to allow the substrate to be folded into a compact configuration.

According to another aspect of the invention, the lengths of the frame members are varied such that the hinges are offset from each other in a folded configuration.

According to another aspect of the invention, a graphics installation system includes: a sheet-like substrate adapted to display graphics disposed thereon; a perimeter frame attached to the substrate of rigid bars carried by the substrate extending along the respective opposed edges; a supporting structure having a face for receiving the substrate; and a plurality of resilient mounts carried by the substrate and engaging the rigid bars so as to position the substrate in a tensioned condition in front of the face.

According to another aspect of the invention, a graphics substrate includes: a sheet-like body adapted to display graphics disposed thereon; and a reinforcement extending around a perimeter of the substrate.

According to another aspect of the invention, the total area of the perimeter reinforcement is limited to about 50% or less of the total area of the body.

According to another aspect of the invention, the perimeter reinforcement is attached to a face of the body.

According to another aspect of the invention, the perimeter reinforcement is embedded within the body.

### BRIEF DESCRIPTION OF THE DRAWINGS

The invention may be best understood by reference to the following description taken in conjunction with the accompanying drawing figures in which:

FIG. 1 is a perspective view of an advertising display constructed according an aspect of present invention;

FIG. 2 is a perspective view of an upper clamp for use with the advertising display;

FIG. 3 is an end view of the upper clamp of FIG. 2;

FIG. 4 is a perspective view of a lower clamp for use with the advertising display;

FIG. 5 is a side view of the lower clamp of FIG. 4;

FIG. 6 is a perspective view of an alternative lower clamp;

FIG. 7 is an end view of an alternative clamp plate;

FIG. 8 is front view of a substrate panel for use with the present invention;

FIG. 9 is a side view of a portion of the graphics substrate of FIG. 8;

FIG. 10 is a front view of a portion of two adjacent substrate panels, showing a first clamping configuration;

FIG. 11 is a front view of a portion of two adjacent substrate panels, showing an alternative clamping configuration;

FIG. 12 is a perspective view of an advertising display constructed according to the present invention;

FIG. 13 is front view of a substrate panel for use with the present invention;

FIG. 14 is a side view of the substrate panel of FIG. 13;

FIG. 15 is a front view of an upper hook assembly for use with the present invention;

FIG. 16 is a front view of an upper clamp for use with the advertising display;

FIG. 17 is an end view of the upper clamp of FIG. 16;

FIG. 18 is a front view of a first substrate panel being attached to the display;

FIG. 19 is an end view of the panel shown in FIG. 18;

FIG. 20 is a front view of a second substrate panel being attached to the display;

FIG. 21 is a perspective view of an advertising display constructed according to an embodiment of the present invention;

FIG. 22 is front view of a substrate panel for use with the present invention;

FIG. 23 is a side view of the substrate panel of FIG. 22;

FIG. 24 is a front, schematic view of upper and lower cable assemblies for use with the present invention;

FIG. 25 is an end view of an upper clamp for use with the advertising display of FIG. 1;

FIG. 26 is a front view of the upper clamp of FIG. 25;

FIG. 27 is a front view of substrate panels being attached to the display;

FIG. 28 is a perspective view of an alternative advertising display constructed according to the present invention;

FIG. 29 is a front view of a mount for use with the display of FIG. 28;

FIG. 30 is an end view of a clip plate for use with the display of FIG. 28, with a substrate panel attached thereto;

FIG. 31 is a front view of the clip plate of FIG. 30;

FIG. 32 is a side view of an alternate structure for attaching a substrate panel;

FIG. 33 is a front view of substrate panels being attached to the display of FIG. 28;

FIG. 34 is a perspective view of an alternative advertising display constructed according to the present invention;

FIG. 35 is a front view of a clip assembly for use with the display of FIG. 34;

FIG. 36 is a rear view of the clip assembly of FIG. 35;

FIG. 37 is a side view of a portion of a substrate panel mounted on a billboard;

FIG. 38 is a front view of substrate panels being attached to the display of FIG. 34;

FIG. 39 is a perspective view of an alternative advertising display constructed according to the present invention;

FIG. 40 is a front view of a substrate panel for use with the present invention;

FIG. 41 is a side view of the substrate panel of FIG. 40;

FIG. 42 is a rear view of the substrate panel of FIG. 40;

FIG. 43 is a side view of a portion of a substrate panel mounted on a billboard;

FIG. 44 is a front view of substrate panels being attached to the display of FIG. 39;

FIG. 45 is a side view of a portion of a billboard with overhanging trim having a panel mounted thereto;

FIG. 46 is a side view of a portion of a billboard with flush trim having a panel mounted thereto;

FIG. 47 is a perspective view of an advertising display constructed according to the present invention;

FIG. 48 is front view of a substrate panel for use with the present invention;

FIG. 49 is a front view of the display of FIG. 47;

FIG. 50 is a perspective view of an alternative advertising display;

FIG. 51 is a front view of a folding configuration for the display of FIG. 50;

FIG. 52 is a side view of a portion of the display of FIG. 50, illustrating a hinge thereof;

FIG. 53 is another view of the hinge of FIG. 52 in a folded condition;

FIG. 54 is a front view of another folding configuration for the display of FIG. 50;

FIG. 55 is a top view of a folded frame;

FIG. 56 is a front view of a graphics substrate constructed according to the present invention;

FIG. 57 is a rear view of the substrate of FIG. 56;

FIG. 58 is a cross-sectional view of a portion of the substrate of FIG. 56;

FIG. 59 is a cross-sectional view of a portion of an alternative substrate;

FIG. 60 is a cross-sectional view of a portion of another alternative substrate; and

FIG. 61 is a cross-sectional view of a portion of yet another alternative substrate.

### DETAILED DESCRIPTION OF THE INVENTION

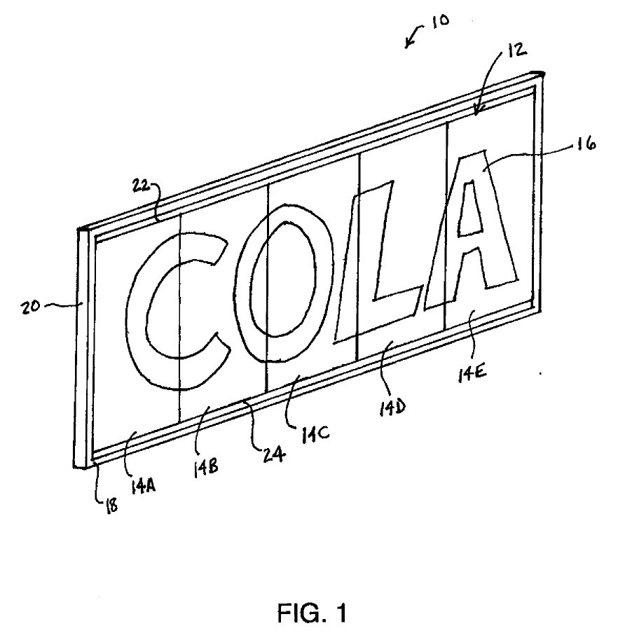

Referring to the drawings wherein identical reference numerals denote the same elements throughout the various views, FIG. 1 illustrates an exemplary advertising display 10 constructed according to the present invention. The advertising display 10 includes a substrate 12 made up of a plurality of panels 14A-14E carrying graphics 16. The panels 14 are attached to the face 18 of a billboard 20 by upper and lower clamps 22 and 24.

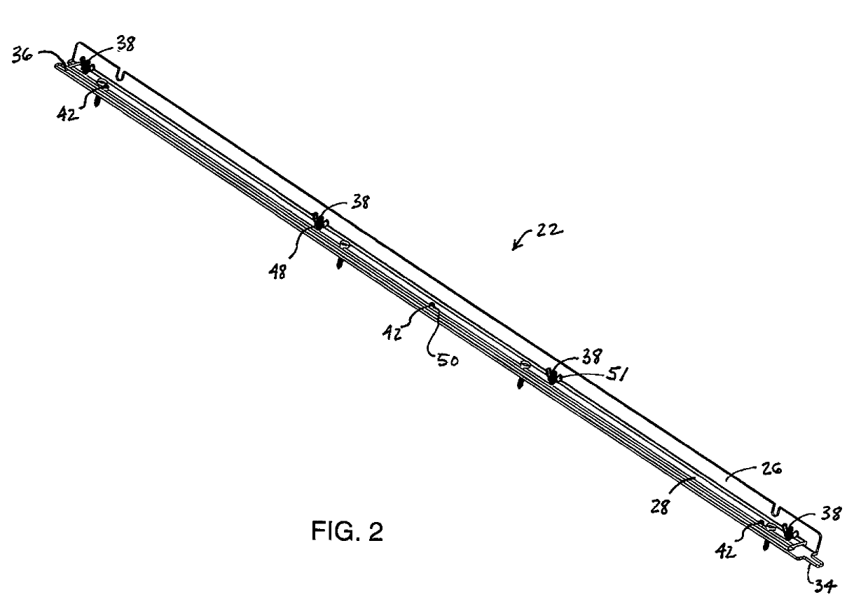

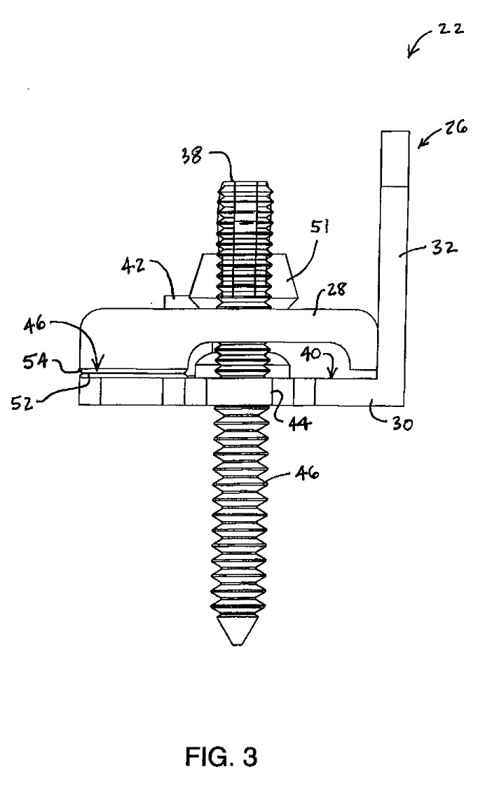

FIGS. 2 and 3 illustrate the upper clamp 22 in more detail. It includes an upper backing plate 26 and an upper clamp plate 28. The upper backing plate 26 is an elongated member having a generally “L”-shaped cross-section with a vertical leg 30 and a horizontal leg 32. A first end of the upper backing plate 26 has an alignment tab 34 extending therefrom, and the opposite end has a complementary alignment slot 36 formed therein. A plurality of spaced-apart threaded studs 38 protrude from the outer face 40 of the vertical leg 30. A plurality of upper registration pins 42 also extend from the outer face 40. A series of mounting holes 44 receive fasteners such as the illustrated screws 46 which secure the upper backing plate 26 to the billboard 20.

The upper clamp plate 28 is an elongated member with a clamping surface 46 facing the upper backing plate 26. The upper clamp plate 28 includes a plurality of through-holes 48 positioned in alignment with the studs 38, and a plurality of clearance holes 50 positioned in alignment with the upper registration pins 42. Wing nuts 51 are screwed on the studs 38 to retain the upper clamp plate 28.

An inner grip pad 52 of a resilient material is attached to the upper backing plate 26, and a resilient outer grip pad 54 is attached to the clamping surface 46 of the upper clamp plate 28. The grip pads 52 and 54 may be constructed from a material such as synthetic rubber.

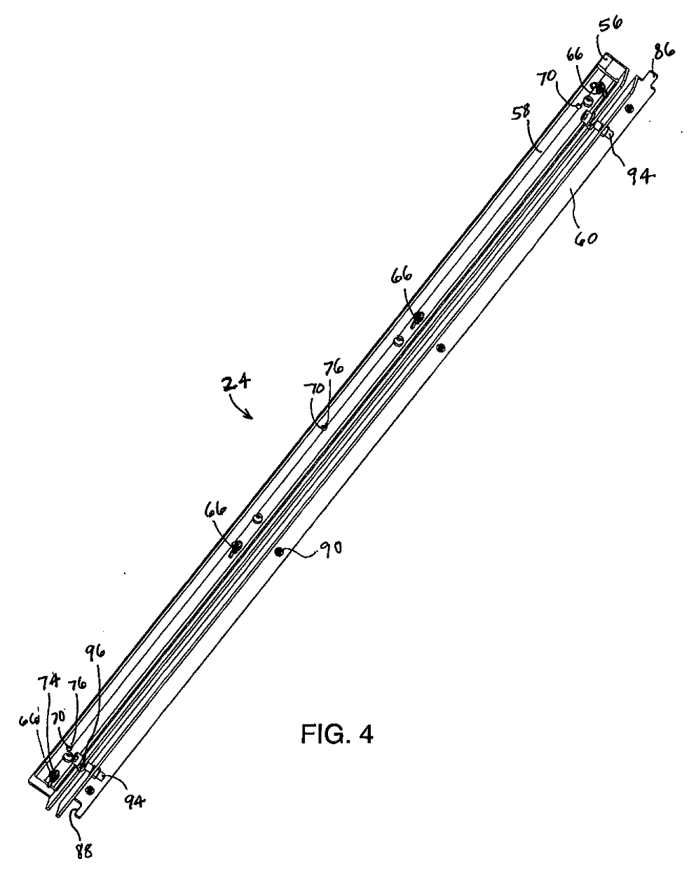

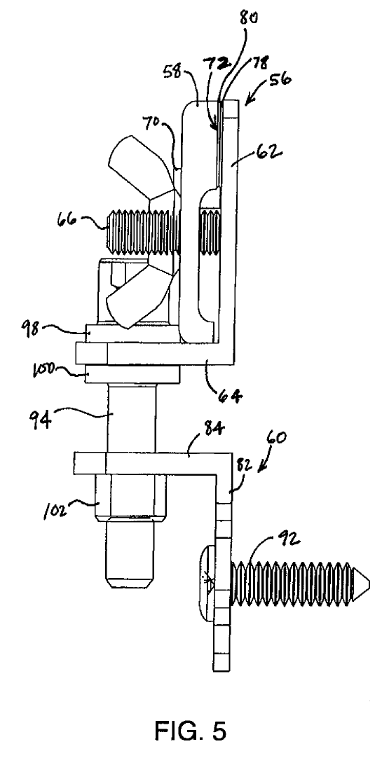

FIGS. 4 and 5 illustrate the lower clamp 24 in more detail. It is similar in construction to the upper clamp 22 and includes a lower backing plate 56, a lower clamp plate 58, and a lower mounting bracket 60. The lower backing plate 56 is an elongated member having a generally “L”-shaped cross-section with a vertical leg 62 and a horizontal leg 64. A plurality of spaced-apart threaded studs 66 protrude from the outer face 68 of the vertical leg 62. A plurality of lower registration pins 70 also extend from the outer face 68.

The lower clamp plate 58 is an elongated member with a clamping surface 72 facing the lower backing plate 56. The lower clamp plate 58 includes a plurality of through-holes 74 positioned in alignment with the studs 66, and a plurality of clearance holes 76 positioned in alignment with the lower registration pins 70. Wing nuts 77 are screwed on the studs 66 to retain the lower clamp plate 58.

An inner grip pad 78 of a resilient material is attached to the lower backing plate 56, and a resilient outer grip pad 80 is attached to the clamping surface 72 of the lower clamp plate 58. The grip pads 78 and 80 may be constructed from a material such as synthetic rubber.

The lower mounting bracket 60 is an elongated member having a generally “L”-shaped cross-section with a vertical leg 82 and a horizontal leg 84. A first end of the lower mounting bracket 60 has an alignment tab 86 extending therefrom, and the opposite end has a complementary alignment slot 88 formed therein. A series of mounting holes 90 receive fasteners such as the illustrated screws 92 which secure the lower mounting bracket 60 to the billboard 20.

The lower backing plate 56 is connected to the lower mounting bracket with one or more tension adjusters that allow adjustment of the distance therebetween. In the example illustrated in FIGS. 4 and 5, the tension adjusters are adjusting screws 94 which are received in slots 96 in the horizontal leg 64 of the lower backing plate 56 and captured in a vertical direction by upper and lower flanges 98 and 100. The adjusting screws 94 are screwed into threaded inserts 102 carried by the lower mounting bracket 60. Rotation of the adjusting screws 94 causes the lower backing plate 56 to be drawn towards the lower mounting bracket 60 or forced away from it, depending upon the direction of rotation.

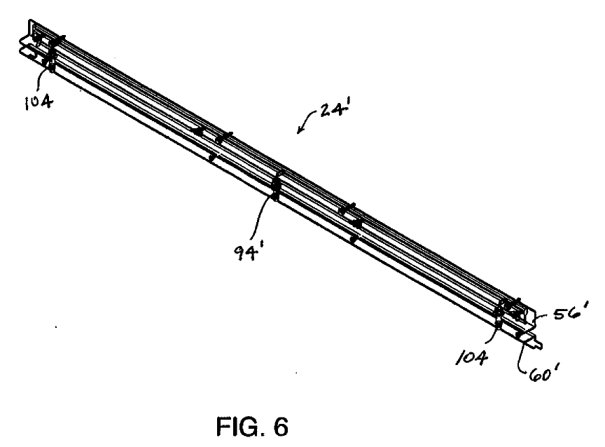

In an alternative embodiment shown in FIG. 6, a lower clamp 24′ is provided with a single adjusting screw 94′ of the type described above, and one or more clamp screws 104 which are screwed into the lower mounting plate 104. These clamp screws 104 function to pull the lower backing plate 56′ towards the lower mounting plate 60′ but do not force the two apart when loosened. It is noted that the specific tension adjusters described herein may be replaced with other types of devices, for example spring-loaded tensioners, so long as they permit tension adjustment over a continuous range.

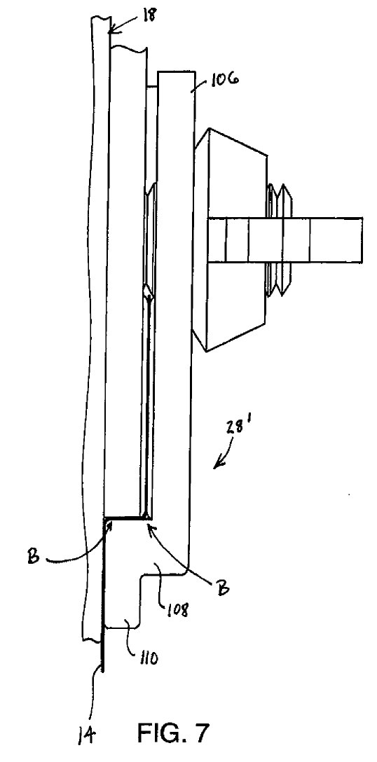

FIG. 7 illustrates an alternative upper clamp plate 28′ which has an offset cross-section made up of a vertical section 106, a lateral section 108, and a vertical flange 110. This offset, in conjunction with the upper backing plate 26, creates two right-angle bends “B” in a substrate panel 14. This improves the gripping power of the upper clamp 22 and also presses the panel 14 against the billboard face 18. The alternative upper clamp plate 28′ may also be used with the lower clamp 24.

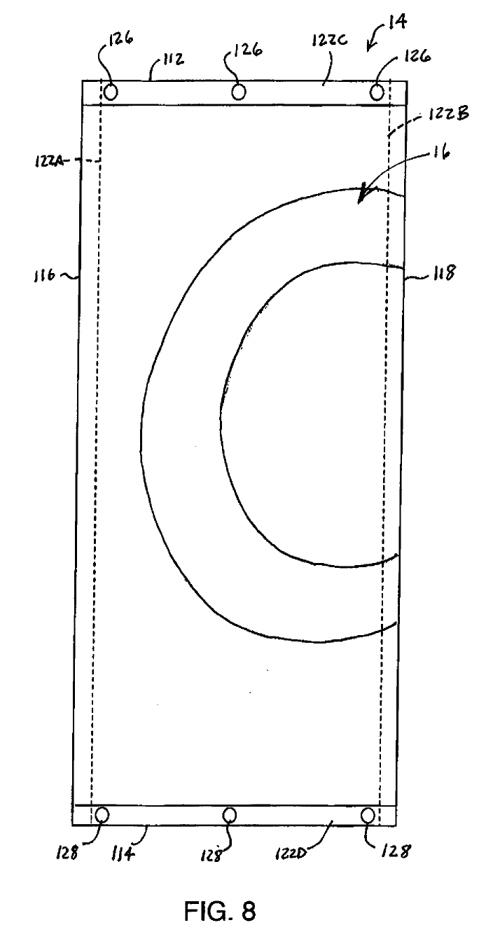

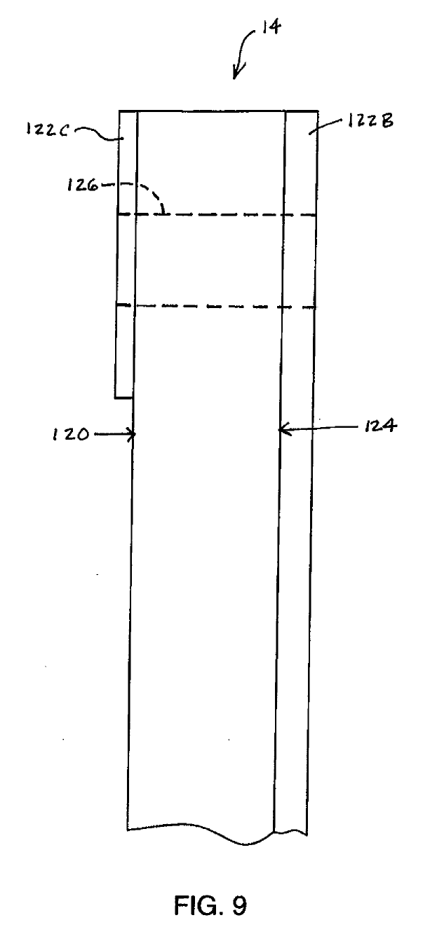

FIGS. 8 and 9 illustrate an exemplary panel 14 of the substrate 12, which is representative of all of the panels 14A-14E. The panel 14 is a sheet-like member having opposed top and bottom edges 112 and 114, and left and right edges 116 and 118. A front side 120 of the panel 14 has a graphic 16 applied thereto, for example by screen printing, painting, dying, or the like. The panel 14 may be constructed from any material which can be fabricated in the desired shape and capable of carrying graphics thereon. Examples of suitable materials include paper, fiberboard, or other similar fibrous materials, fabrics, plastic, thin sheet metal, and the like.

Optionally, one or more reinforcing strips 122 are applied to selected edges of the panel 14 to improve its tensile strength. In the illustrated example, reinforcing strips 122A and 122B are applied to the back side 124 of the panel 14 along the left and right edges 116 and 118. Reinforcing strips 122C and 122D are applied to the front side 120 of the panel 14 along its top and bottom edges 112 and 114. It has been found that a combination of a paper substrate with the above-described reinforcing strips 122 is cost effective relative to other combinations of materials.

The material and dimensions of the reinforcing strips 122 are selected to provide adequate tensile strength to resist the loads of the clamps, taking into consideration the overall size of the panels 14. In this particular example, the reinforcing strips 122 are made from fiber-reinforced polypropylene coated on one side with pressure-sensitive adhesive, similar to common “strapping tape”. The reinforcing strips 122 are about 2.5 cm (1 in.) wide, with a thickness of about 0.08 mm (0.003 in.) to about 0.13 mm (0.005 in.)

Arrays of upper and lower registration holes 126 and 128 are formed near the top and bottom edges 112 and 114, respectively, of the panel 14. These registration holes 126 and 128 are positioned in a predetermined pattern relative to the registration pins 42 and 70 to provide the desired alignment of the panel 14. The registration holes 126 and 128 are positioned relative to the graphics 16 rather than the panel 14. This ensures that the graphics 16 will have the desired alignment with the billboard 20 even if they are misaligned with the panel 14.

The advertising display 10 is assembled as follows. The upper clamp 22 is attached near the upper end of the billboard 20 using the mounting screws 46 described above, an adhesive, or another suitable method. As many segments are used as required depending upon the width of the billboard 20. In the illustrated example, each segment is about 1.4 m (55 in.) wide, and the total width of the billboard 20 is about 7 m (272 in.) As each segment of the upper clamp 22 is installed, its alignment tab 34 is fitted into the alignment slot 36 of the adjacent segment. This helps ensure that the upper clamp 22 extends in a straight line across the billboard 20.

The lower clamp 24 is attached near the lower end of the billboard 20 using the mounting screws 92 described above, an adhesive, or another suitable method. As many segments are used as required, depending upon the width of the billboard 20. As each segment of the lower clamp 24 is installed, its alignment tab 86 is fitted into the alignment slot 88 of the adjacent segment. It should be noted that the upper and lower clamps 22 and 24 may be attached to a new billboard 20, or they may be attached to an existing billboard in order to convert it to the attachment method of the present invention.

The substrate 12 is mounted to the billboard 20 one panel at a time. First the wing nuts 51 of the upper clamp 22 are loosened and the upper clamp plate 28 is pulled away from the upper backing plate 26. The top edge 112 of a first panel 14A of the substrate 12 is placed against the upper backing plate 26 with the upper registration pins 42 in the upper registration holes 126. The wing nuts 51 are then tightened to draw the upper clamp plate 28 against the upper backing plate 26 and press the upper edge 112 of the panel 14A between the upper grip pads 52 and 54.

Next, the wing nuts 77 of the lower clamp 24 are loosened and the lower clamp plate 58 is pulled away from the lower backing plate 56. The bottom edge 114 of the first panel 14A is placed against the lower backing plate 56 with the lower registration pins 70 in the lower registration holes 128. The wing nuts 77 are then tightened to draw the lower clamp plate 58 against the lower backing plate 56 and press the lower edge 114 of the panel 14A between the lower grip pads 78 and 80.

Next, the panel 14A is tensioned by turning the adjusting screws 94, drawing the lower backing plate 56 towards the lower mounting bracket 60 and putting tension in the first panel 14A, causing it to lie flat against the billboard face 18 and removing any wrinkles therein.

The process of installation and tensioning is repeated with additional substrate panels 14 and segments of the upper and lower clamp assemblies 22 and 24 until the billboard face 18 is covered to the desired degree. Typically, the panels 14 are installed with some degree of overlap to ensure that a continuous image is presented. An example of a suitable amount of overlap is about 2.5 cm (1 in.) It is also desirable to be able to install and secure one panel 14 to the billboard 20 at a time.

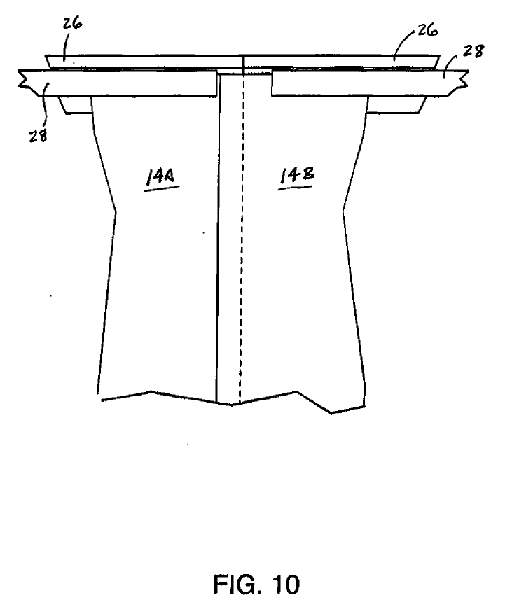

This overlap and sequential attachment of the substrate 12 may be accommodated in various ways. FIG. 10 illustrates a first configuration and shows the upper ends of two adjacent panels 14A and 14B. This is also representative of the configuration at the lower end of the panels 14. Each panel 14 is approximately the same width as its associated upper backing plate 26, and is centered left-to-right with respect thereto. The associated upper clamp plates 28 are centered on their respective upper backing plates 26, but are narrower than the panels 14 so that the adjacent panel 14B can overlap the first panel 14A. In this configuration, the left and right edges of the panels 14 are not clamped.

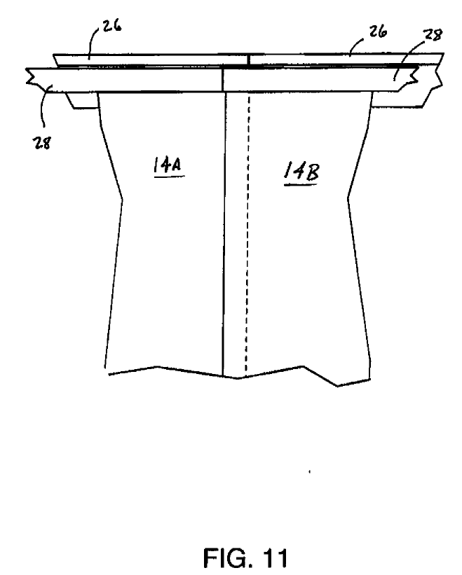

Alternatively, the clamp plates can be configured to provide continuous coverage. FIG. 11 illustrates a configuration in which the joints between adjacent upper clamp plates 28 are staggered relative to the joints between the upper backing plates 26. This is also representative of the configuration at the lower end of the panels 14. This configuration may require the use of upper clamp plates 28 of unequal length to provide complete coverage.

The above described installation system has several advantages. It eliminates the need for adhesives, allows full-height panel sections, and guarantees a desired registration between panels. It may be used in any application requiring a segmented display. For example, it could be used on trucks and the like.

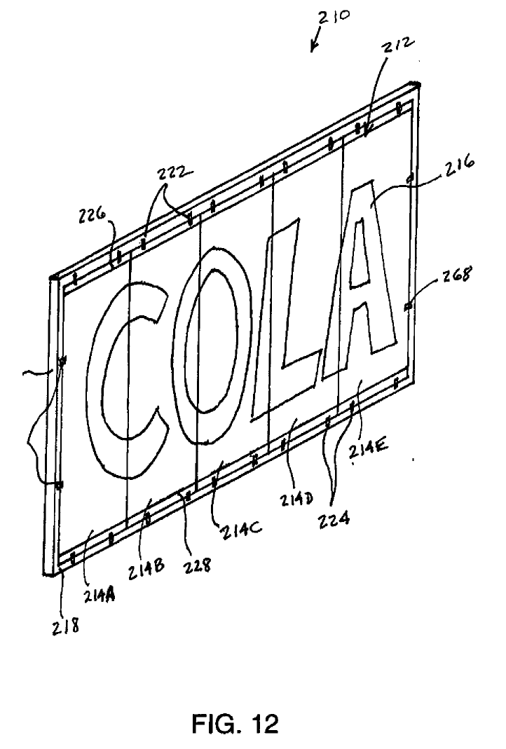

FIG. 12 illustrates an alternative advertising display 210 constructed according to the present invention. The advertising display 210 includes a substrate 212 made up of a plurality of panels 214A-214E carrying graphics 216. The panels 214 are attached to the face 218 of a billboard 220 by upper and lower hook assemblies 222 and 224, and upper and lower clamps 226 and 228.

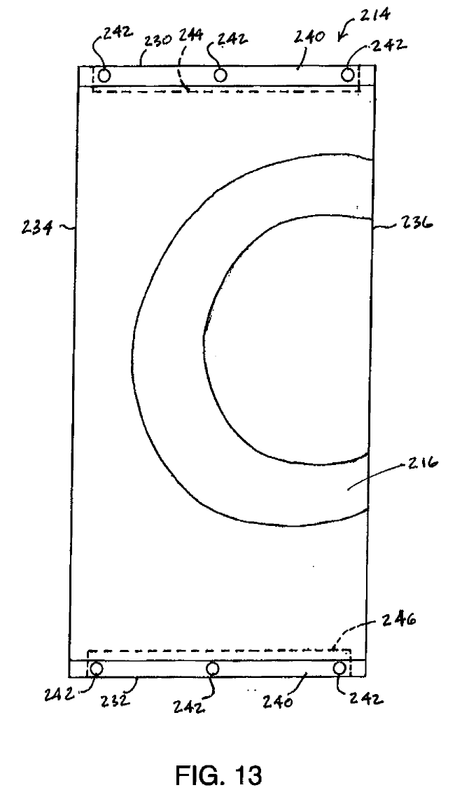

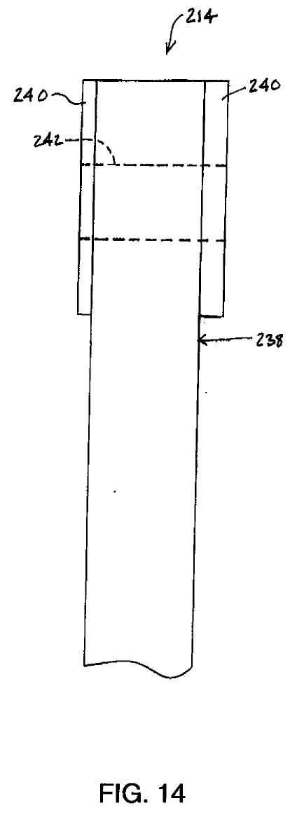

FIGS. 13 and 14 illustrate an exemplary panel 214 of the substrate 212, which is representative of all of the panels 214A-214E. The panel 214 is a sheet-like member having opposed top and bottom edges 230 and 232, and left and right edges 234 and 236. A front side 238 of the panel 214 has a graphic 216 applied thereto, for example by screen printing, painting, dying, or the like. The panel 214 may be constructed from any material which can be fabricated in the desired shape and capable of carrying graphics thereon. Examples of suitable materials include paper, fiberboard, or other similar fibrous materials, fabrics, plastic, thin sheet metal, and the like.

Optionally, reinforcing strips 240 may be applied to one or both sides of the panel 214 along its top and bottom edges 230 and 232. The reinforcing strips 240 may be made of a material such as polyethylene or light metal and attached to the panel 214 with an adhesive. The reinforcing strips have mounting holes 242 formed therethrough which allow direct attachment of the panel 214 to the hook assemblies 222 and 224. Indicia which indicate upper and lower “clip areas” 244 and 246 where the clamps 226 and 228 should be attached to the panel 214 are disposed near the top and bottom edges 230 and 232, respectively, of the panel 214.

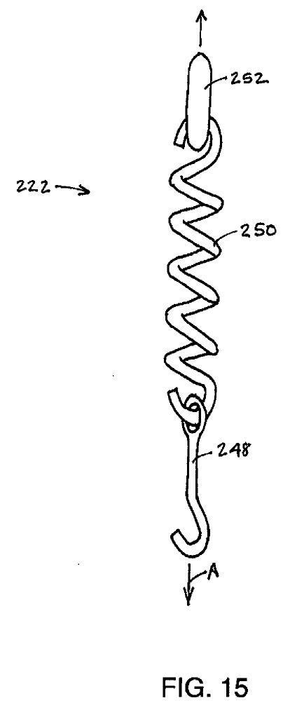

FIG. 15 illustrates one of the upper hook assemblies 222. It includes an upper hook 248 which is mounted to the billboard 220 by a tensioning device such as the illustrated spring 250 and screw eye 252. The upper hook 248 is free to swing or pivot to some degree relative to the surface of the billboard 220, but produces a tension force when it is extended along its axis “A”. A plurality of these upper hook assemblies 222 are mounted in a row along the upper portion of the billboard 220 with a pattern and spacing corresponding to the number of panels 214 and their width. Preferably, at least two upper hook assemblies 222 are provided for each panel 214.

A plurality of lower hook assemblies 224 are mounted in another row along the lower portion of the billboard 220 (see FIG. 12). In the illustrated example, the lower hook assemblies 224 are substantially identical in construction to the upper hook assemblies 222. It is also possible that the lower hook assemblies 224 could be simple hooks without a tensioning mechanism, in which case the upper hook assemblies 222 would provide all of the tension. The reverse arrangement is also possible.

The hook assemblies 222 and 224 described above are merely examples of suitable tensioning mechanisms. Other devices and mechanical configurations could be substituted therefor so long as they are capable of providing tension in the panels 214 and allowing some lateral motion of the panel relative to the billboard 220. For example, the hook assemblies 222 and 224 could be arranged so that the tensioning mechanisms are hidden from view with only the hooks being visible.

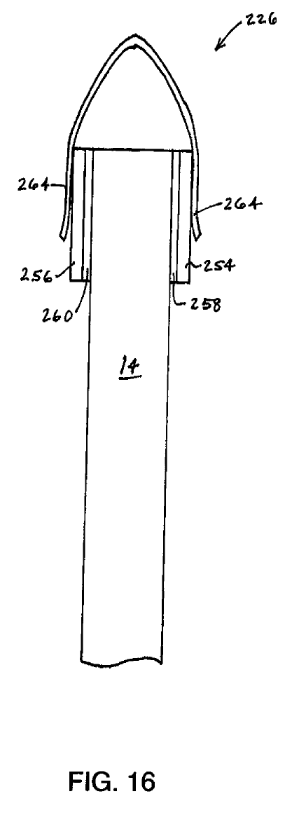

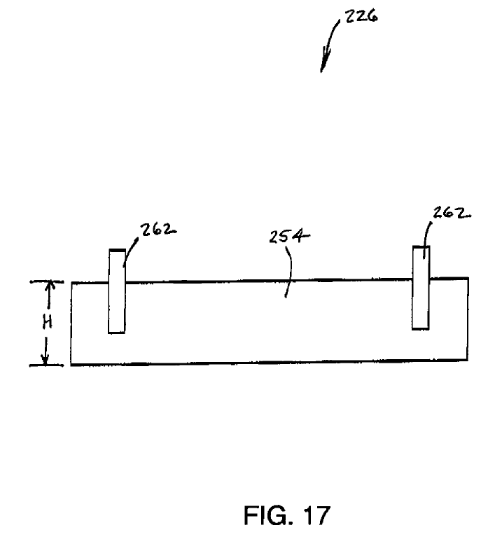

FIGS. 16 and 17 illustrate one of the upper clamps 226 in more detail. It includes relatively narrow, laterally-elongated front and back plates 254 and 256 which are adapted to be positioned along the top edge of one of the panels 214. In the illustrated example, the front and back plates 254 and 256 are aluminum extrusions with a height “H” of about 13 cm (0.5 in.), so that they can be hidden under trim pieces when mounted to the billboard 220. Optional resilient grip pads 258 and 260 may be attached to the clamping surfaces of the front and back plates 254 and 256, respectively. The grip pads 258 and 260 may be constructed from a material such as synthetic rubber.

The upper clamp 226 includes means to clamp the panel 214 between the front and back plates 254 and 256. In the illustrated example, one or more “U”-shaped spring clips 262 with spaced-apart legs 264 are placed down over the front and back plates 254 and 256 to clamp them together. The front and back plates 254 and 256 could also be clamped together with other kind of springs, secured with adhesives, or attached to each other with fasteners such as screws or rivets. As an alternative, the upper clamps 226 could be made as integral units without separate clamping means.

A plurality of lower clamps 228 are provided for the bottom edge of the panels 14. They are substantially identical in construction to the upper clamps 26 described above.

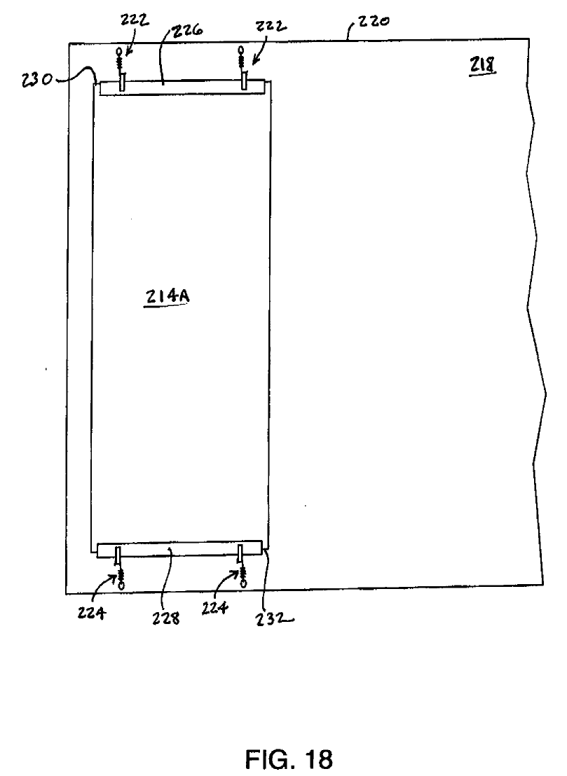

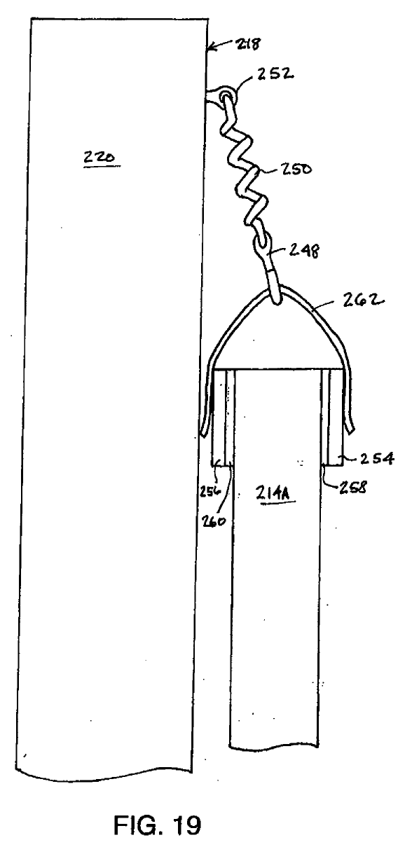

Referring now to FIGS. 18 and 19, the substrate 212 is mounted to the billboard 220 as follows. The upper clamp 226 is attached to the top edge 230 of a first panel 214A of the substrate 212, and the lower clamp 228 is attached to the bottom edge 232 of the first panel 214A. The upper clamp 226 is connected to the upper hook assemblies 222 by engaging the upper hooks 248 with the clips 262, and the lower clamp 228 is connected to the lower hook assemblies 224 in a similar manner. When the hook assemblies 222 and 224 are released after engagement, they tension the first panel 214A in a vertical direction and also pull it against the billboard 220 as shown in FIG. 19. The hook assemblies 222 and 224 thus tend to hold the panel 214A in place by friction so that the panel 214A can be moved laterally to some degree as desired for proper positioning. If the panel 214A is provided with reinforcing strips as described above, then the hook assemblies 222 and 224 are connected directly to the mounting holes 244 in the panel 214A without the use of the clamps 226 and 228.

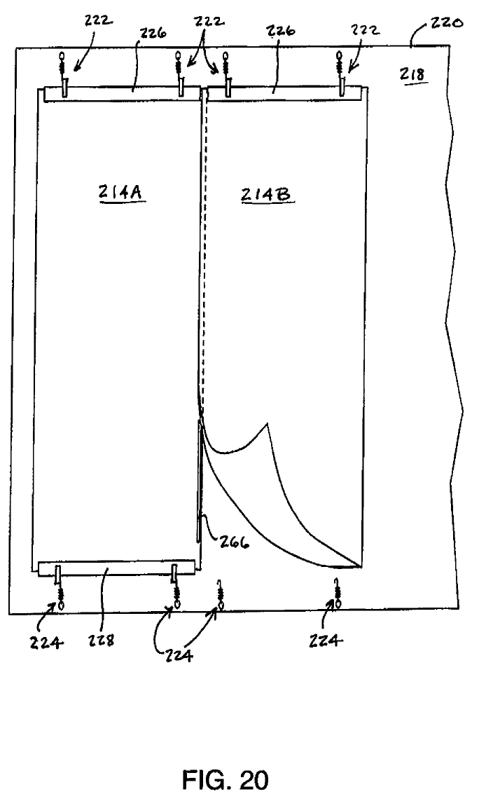

After the first panel 214A is in place, a second panel 214B may be hung from the upper hook assemblies as described above (with or without clamps 226 and 228) and is moved to the desired lateral relationship with the first panel 214A (see FIG. 20). The panels 214A and 214B may be placed edge-to-edge. Preferably, however, the panels 214A and 214B are overlapped to some degree so that any misalignment or motion from winds will not expose gaps. An example of a suitable amount of overlap is about 2.5 cm (1 in.).

If desired, means may be provided for securing the adjacent panels 214 together. Examples of suitable materials include double-sided tape 266 applied between the panels 214A and 214B, transparent tape applied over the front of the joint between the panels 214A and 214B, adhesives, mechanical fasteners or the like.

Once the second panel 214B is properly aligned, its bottom edge is attached to the lower hook assemblies 224 in the same manner as for the first panel. The attachment process is then repeated until the billboard face 218 is covered to the desired degree. If desired, the outermost left and right vertical edges of the substrate 212 may be secured to the billboard 220 using tape, adhesives, a trim panel, or the like. Also, if desired, side hook assemblies 268 similar in construction to the upper hook assemblies 222 may be provided to tension the substrate in a lateral direction.

The above described installation system has several advantages. It eliminates the need for adhesives, allows full-height panel sections, and allows easy adjustment of registration between panels. It may be used in any application requiring a segmented display. For example, it could be used on trucks and the like.

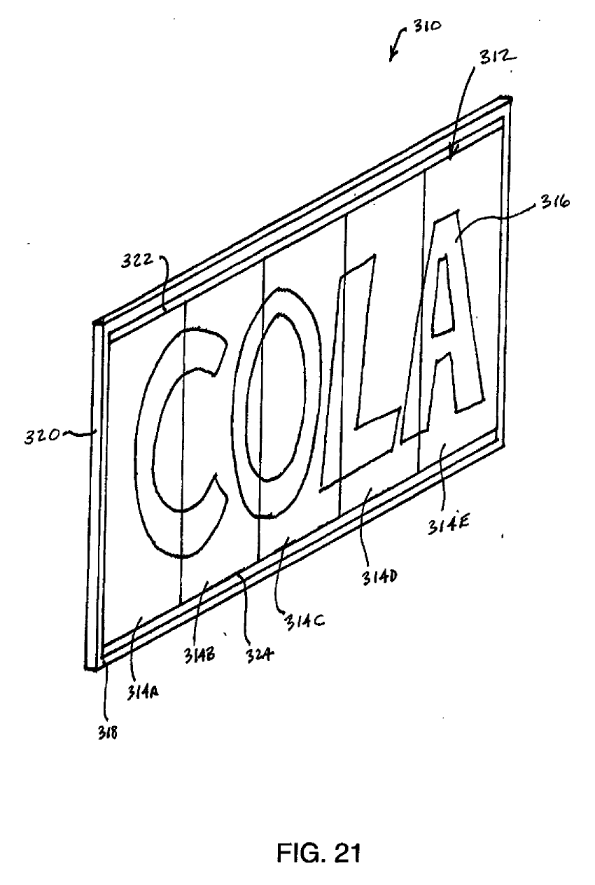

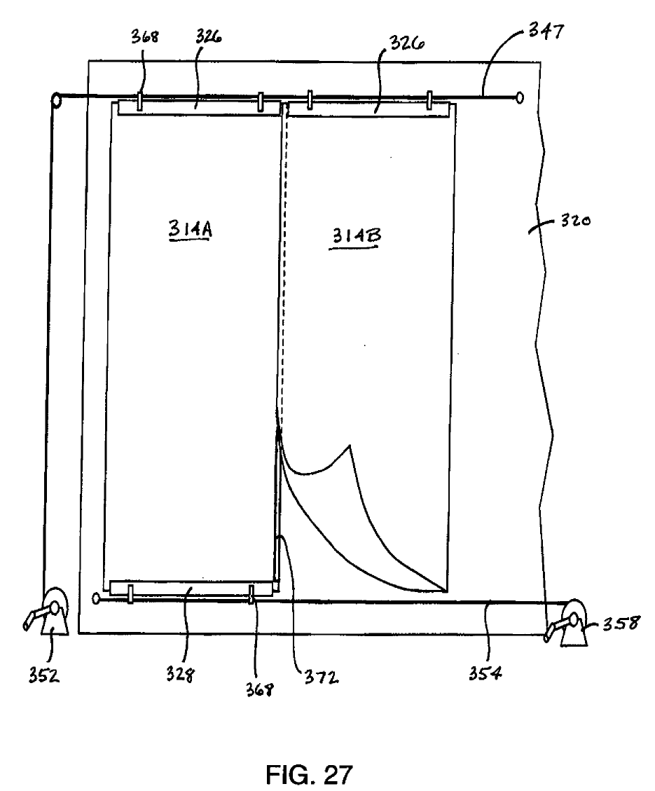

FIG. 21 illustrates an alternative advertising display 310 constructed according to the present invention. The advertising display 310 includes a substrate 312 made up of a plurality of panels 314A-314E carrying graphics 316. The panels 314 are attached to the face 318 of a billboard 320 by upper and lower cable assemblies 322 and 324, and upper and lower clamps 326 and 328 (see FIG. 27).

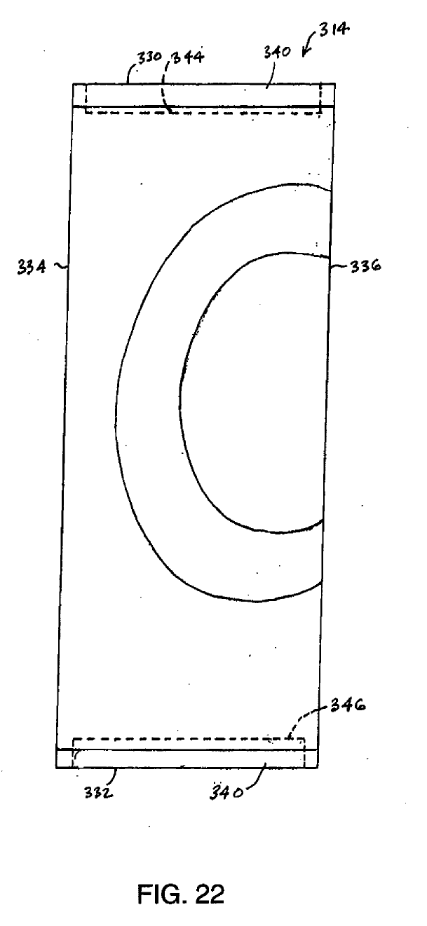

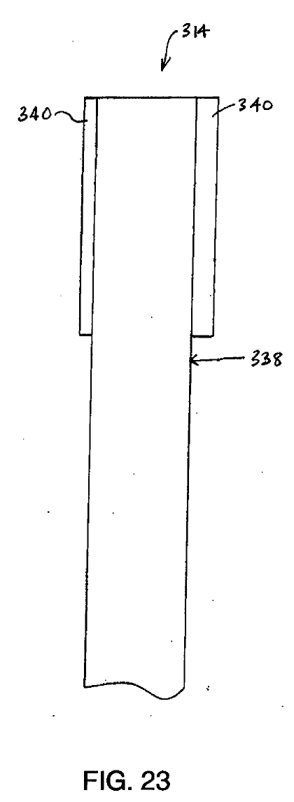

FIGS. 22 and 23 illustrate an exemplary panel 314 of the substrate 312, which is representative of all of the panels 314A-314E. The panel 314 is a sheet-like member having opposed top and bottom edges 330 and 332, and left and right edges 334 and 336. A front side 338 of the panel 314 has a graphic 316 applied thereto, for example by screen printing, painting, dying, or the like. The panel 214 may be constructed from any material which can be fabricated in the desired shape and capable of carrying graphics thereon. Examples of suitable materials include paper, fiberboard, or other similar fibrous materials, fabrics, plastic, thin sheet metal, and the like.

Optionally, reinforcing strips 340 may be applied to one or both sides of the panel 314 along its top and bottom edges 330 and 332. The reinforcing strips 340 may be made of a material such as polyethylene or light metal and attached to the panel 314 with an adhesive. Indicia which indicate upper and lower “clip areas” 344 and 346 where the clamps 326 and 328 should be attached to the panel 314 are disposed near the top and bottom edges 330 and 332, respectively, of the panel 314.

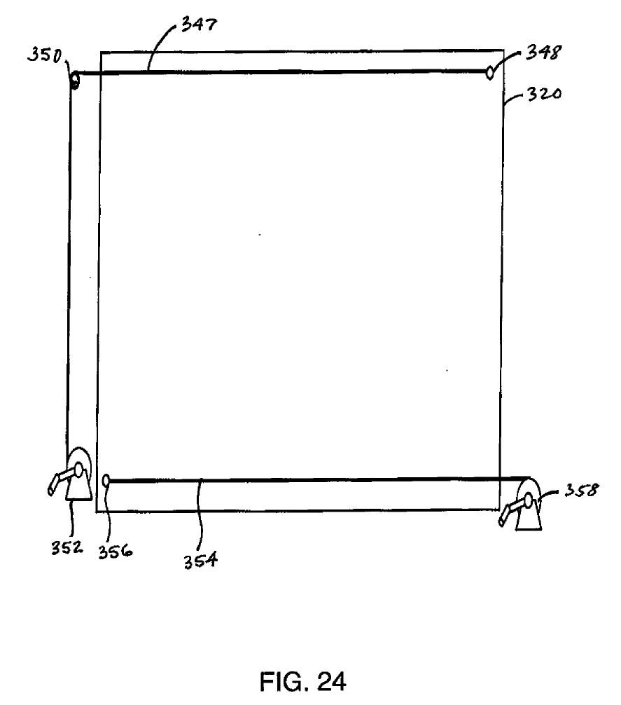

FIG. 24 illustrates the upper cable assembly 322. It includes an upper cable 47 which is anchored to the billboard 320, for example with the illustrated screw eye 348. Means are provided for tensioning the upper cable 322. In the illustrated example, the upper cable 347 is routed over an upper pulley 350 and then downwards to a ratchet winch 352 of a known type mounted near the bottom of the billboard 320.

The lower cable assembly 324 includes a lower cable 354 which is anchored along the lower edge of the billboard 320, for example with the illustrated screw eye 356. Means are provided for tensioning the lower cable 322. In the illustrated example, the lower cable 354 is routed to a ratchet winch 58 of a known type mounted near the bottom of the billboard 320.

The cable assemblies 322 and 324 described above are merely examples of suitable tensioning mechanisms. Other devices and mechanical configurations could be substituted therefor so long as they are capable of providing tension in the upper and lower cables 346 and 354 and allowing some lateral motion of the panel 314 relative to the billboard 320.

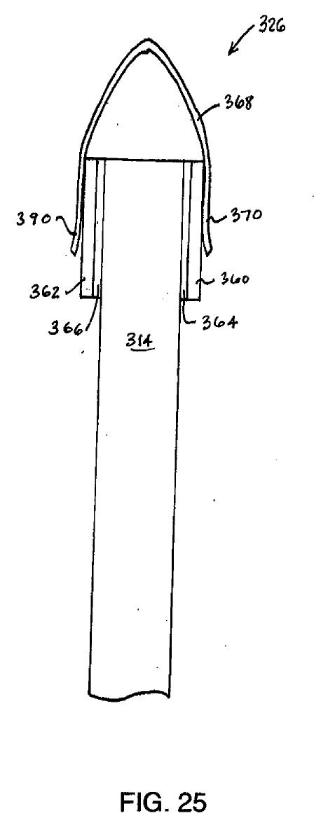

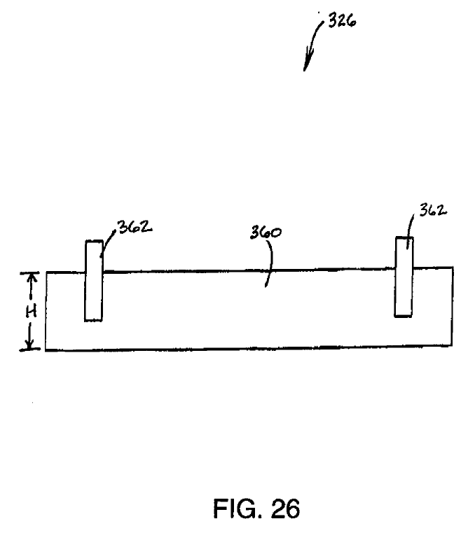

FIGS. 25 and 26 illustrate one of the upper clamps 326 in more detail. It includes relatively narrow, laterally-elongated front and back plates 360 and 362 which are adapted to be positioned along the top edge of one of the panels 14. In the illustrated example, the front and back plates 360 and 362 are aluminum extrusions with a height “H” of about 13 cm (0.5 in.), so that they can be hidden under trim pieces when mounted to the billboard 320. Optional resilient grip pads 364 and 366 may be attached to the clamping surfaces of the front and back plates 360 and 362, respectively. The grip pads 364 and 366 may be constructed from a material such as synthetic rubber.

The upper clamp 326 includes means to clamp the panel 314 between the front and back plates 360 and 362. In the illustrated example, one or more “U”-shaped spring clips 368 with spaced-apart legs 370 are placed down over the front and back plates 360 and 362 to clamp them together. The front and back plates 360 and 362 could also be clamped together with other kind of springs, secured with adhesives, or attached to each other with fasteners such as screws or rivets. As an alternative, the upper clamps 326 could be made as integral units without separate clamping means.

A plurality of lower clamps 328 are provided for the bottom edge of the panels 314. They are substantially identical in construction to the upper clamps 326 described above.

Referring now to FIG. 27, the substrate 312 is mounted to the billboard 320 as follows. The upper cable 347 is untensioned and allowed to droop near the bottom of the billboard 320. The top edge 330 of a first panel 314A of the substrate 312 is placed between the front and back plates 360 and 362 of the upper clamp 324. The spring clips 368 are placed over the front and back plates and 360 and 362 and over the upper cable 347. This process is repeated with the remaining panels 314B-314E. The upper cable is then tensioned to lift the panels 314 into position.

If desired, means may be provided for securing the adjacent panels 314 together after they have been aligned properly. Examples of suitable materials include double-sided tape 372 applied between the panels 314, transparent tape applied over the front of the joint between the panels 314, adhesives, mechanical fasteners or the like.

After the upper cable 347 is tensioned, the lower clamps 328 are attached to the bottom edges 332 of the panels 314, and to the lower cable 356 in substantially the same way as described for the upper cable 347. The lower cable 356 is then tensioned.

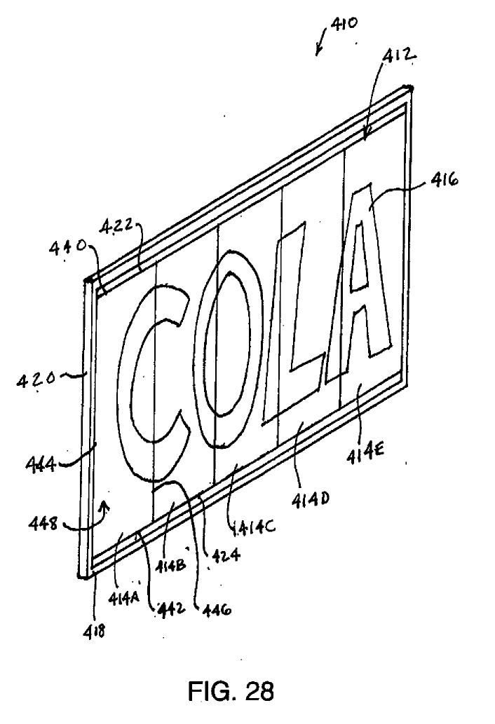

FIG. 28 illustrates an alternative advertising display 410 constructed according to the present invention. The advertising display 410 includes a substrate 412 made up of a plurality of panels 414A-414E carrying graphics 416. The panels 414 are attached to the face 418 of a billboard 420 by upper and lower mounts 422 and 424.

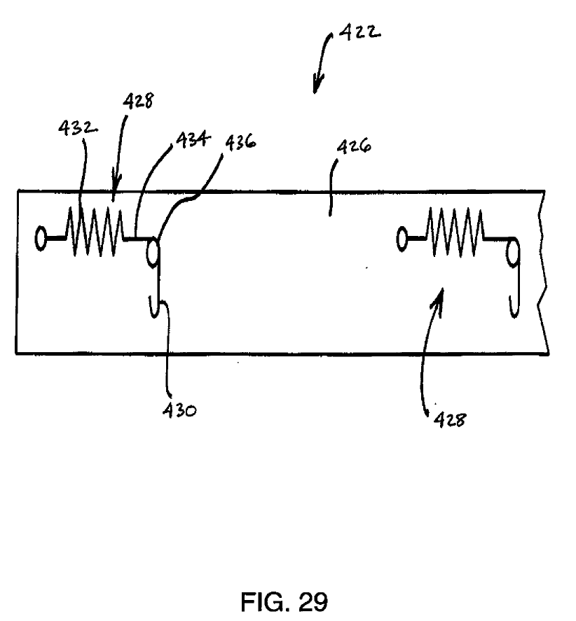

FIG. 29 illustrates one of the upper mounts 422. It includes an elongated base 426 which is mounted to the billboard 420. A plurality of upper hook assemblies 428 are resiliently mounted to the base 426. In the illustrated example, each upper hook assembly 428 includes a hook 430 connected to a horizontally-oriented spring 432 by a filament 434 running over a pulley 436, to minimize the vertical extent of the upper hook assembly 422. The hook 430 is free to swing or pivot to some degree relative to the surface of the billboard 420, but produces a tension force when it is extended along a vertical axis. A plurality of these upper hook assemblies 428 are mounted in a row along the upper portion of the billboard 420 with a pattern and spacing corresponding to the number of panels 414 and their width. Preferably, at least two upper hook assemblies 128 are provided for each panel 414.

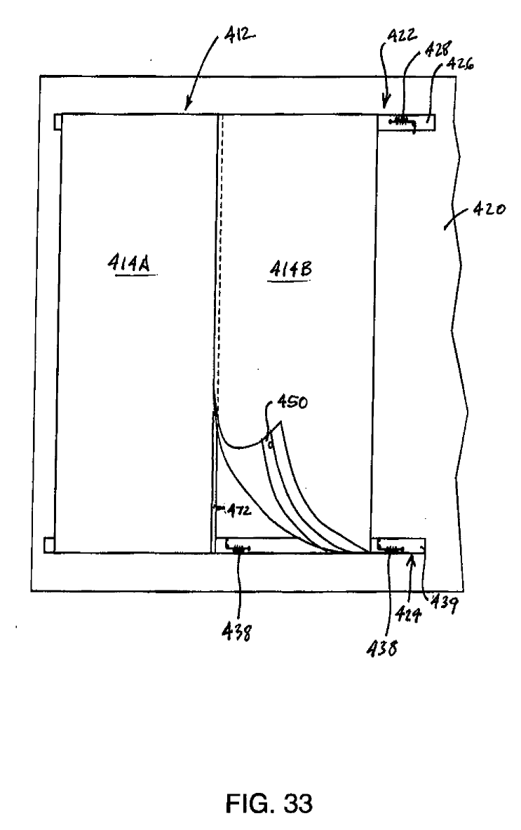

The lower mount 424 (see FIG. 33) carries a plurality of lower hook assemblies 438 on a base 439. In the illustrated example, the lower hook assemblies 438 are substantially identical in construction to the upper hook assemblies 422. It is also possible that the lower hook assemblies 438 could be simple hooks without a tensioning mechanism, in which case the upper hook assemblies 422 would provide all of the tension. The reverse arrangement is also possible.

The upper and lower mounts 422 and 424 described above are merely examples of suitable tensioning mechanisms. Other devices and mechanical configurations could be substituted therefor so long as they are capable of providing tension in the panels 414 and allowing some lateral motion of the panel relative to the billboard 120. For example, the mounts 422 and 424 could be arranged so that the tensioning mechanisms are hidden from view with only the hooks being visible.

The substrate 412 is substantially identical to the substrate 312 described above. Each panel 414A-414E thereof includes opposed top and bottom edges 440 and 442, and left and right edges 444 and 446, as shown in FIG. 28. A front side 448 of the panel 414 has a graphic 416 applied thereto.

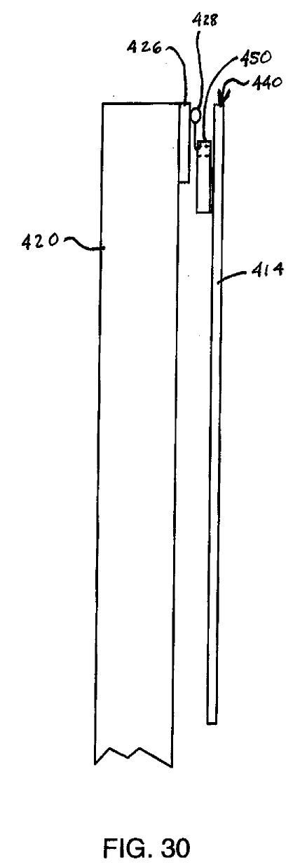

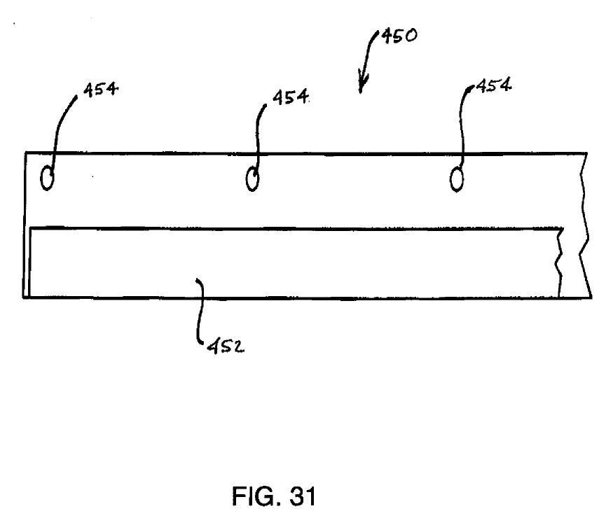

Means are provided for connecting the panels 414 to the mounts 422 and 424. FIGS. 30 and 31 illustrate one possible configuration in which laterally-extending clip plates 450 constructed of plastic or a similar material are attached to the top and bottom edges 440 and 442 of the panel 414 using adhesive 452. Hook holes 454 are formed through the clip plate 450 to receive the hooks 430. As shown in FIG. 3, the clip plate 450 may be attached to the panel 414 in a vertically-offset position so that the top edge 440 of the panel 414 hides the clip plate 450 from view.

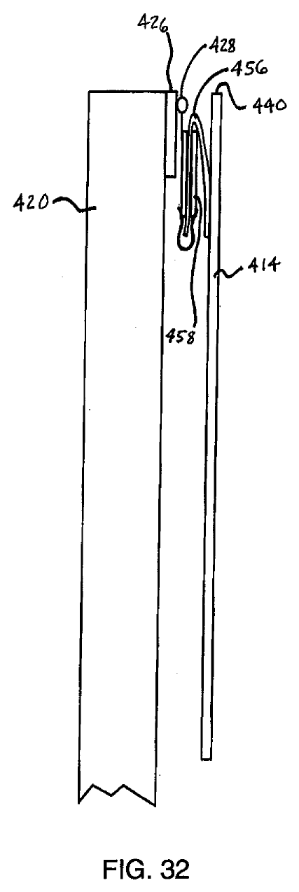

FIG. 32 illustrates another possible configuration in which laterally-extending flaps 456 constructed of plastic or a similar material are attached to the top and bottom edges 440 and 442 of the panel. The flaps 456 are folded inward and received in outwardly-facing clamps 458 which are substantially similar in construction to the clamps 126 described above.

Referring now to FIG. 33, the substrate 412 is mounted to the billboard 420 by hooking it to the upper and lower mounts 422 and 424. When the hook assemblies 428 and 438 are released after engagement, they tension the first panel 414A in a vertical direction and also pull it against the billboard 420. If the offset clip plates 450 or the clamps 458 are used, the edges of the panel 414A will hide the mounts 422 and 424 as shown. The mounts 422 and 424 thus tend to hold the panel 414A in place by friction so that the panel 414A can be moved laterally to some degree as desired for proper positioning.

After the first panel 414A is in place, a second panel 414B may be hung from the mount 422 as described above and is moved to the desired lateral relationship with the first panel 414A. The panels 414A and 414B may be placed edge-to-edge. Preferably, however, the panels 414A and 414B are overlapped to some degree so that any misalignment or motion from winds will not expose gaps. An example of a suitable amount of overlap is about 2.5 cm (1 in.).

If desired, means may be provided for securing the adjacent panels 414 together. Examples of suitable materials include double-sided tape 472 applied between the panels 414A and 414B, transparent tape applied over the front of the joint between the panels 414A and 414B, adhesives, mechanical fasteners or the like.

Once the second panel 414B is properly aligned, its bottom edge is attached to the bottom mounts 424 in the same manner as for the first panel 414A. The attachment process is then repeated until the billboard face 418 is covered to the desired degree. If desired, the outermost left and right vertical edges of the substrate 412 may be secured to the billboard 420 using tape, adhesives, a trim panel, or the like.

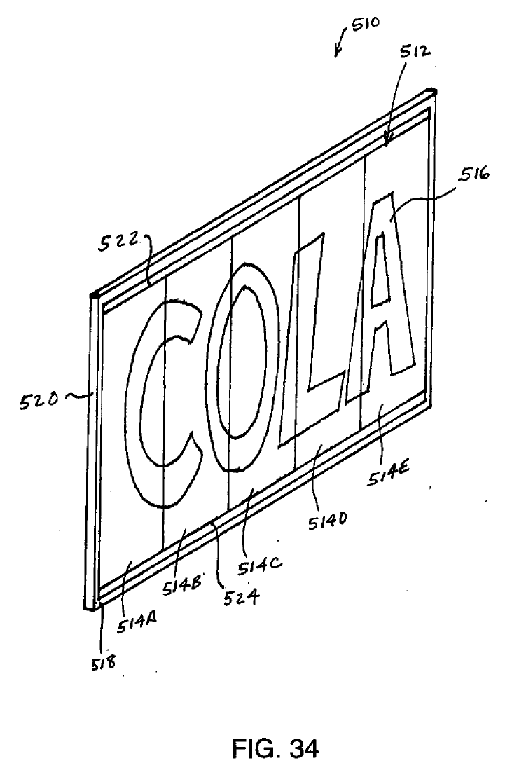

FIG. 34 illustrates an alternative advertising display 510 constructed according to the present invention. The advertising display 510 includes a substrate 512 made up of a plurality of panels 514A-514E carrying graphics 516. The substrate 512 is substantially identical to the substrate 312 described above. The panels 514 are attached to the face 518 of a billboard 520 by upper and lower clip assemblies 522 and 524.

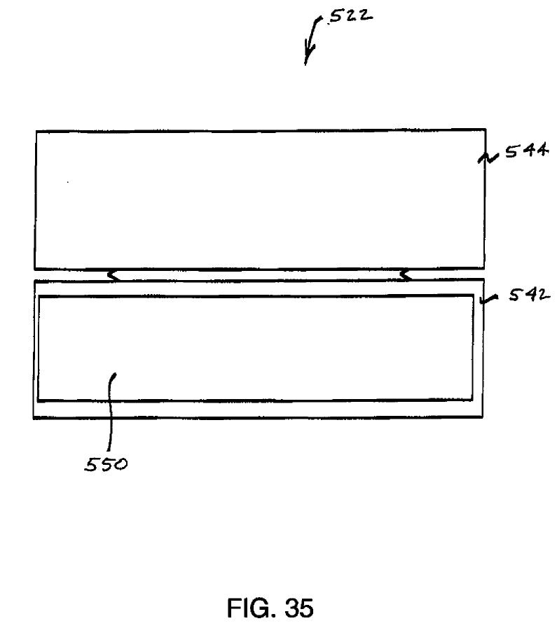

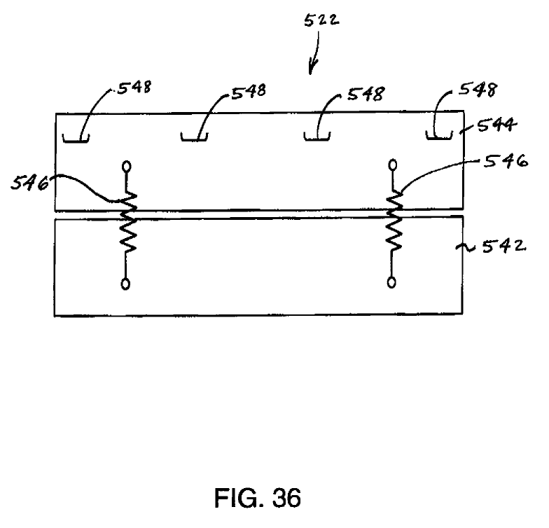

FIGS. 35 and 36 illustrate one of the upper clip assemblies 522 in more detail. It includes a narrow, laterally-elongated clip plate 542 and a narrow, laterally-elongated masking plate 544. The clip plate 542 and the masking plate 544 are interconnected by one or more springs 246 or other resilient members which allow a degree of relative motion. At least one loop 548 is disposed on the back side of the masking plate 544. An adhesive 550 is disposed on the front side of the clip plate 542.

A plurality of lower clip assemblies 524 are provided for the bottom edge of the panels 514. They are substantially identical in construction to the upper clip assemblies 522 described above.

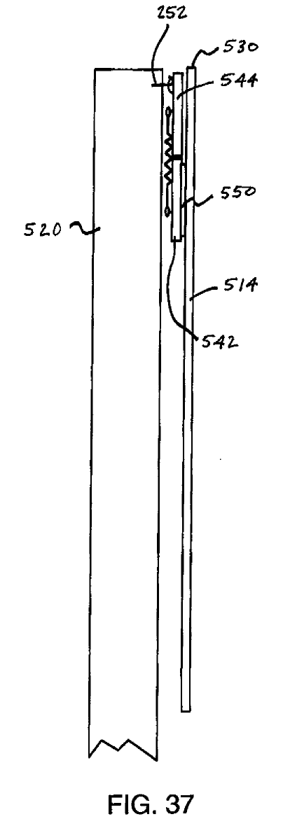

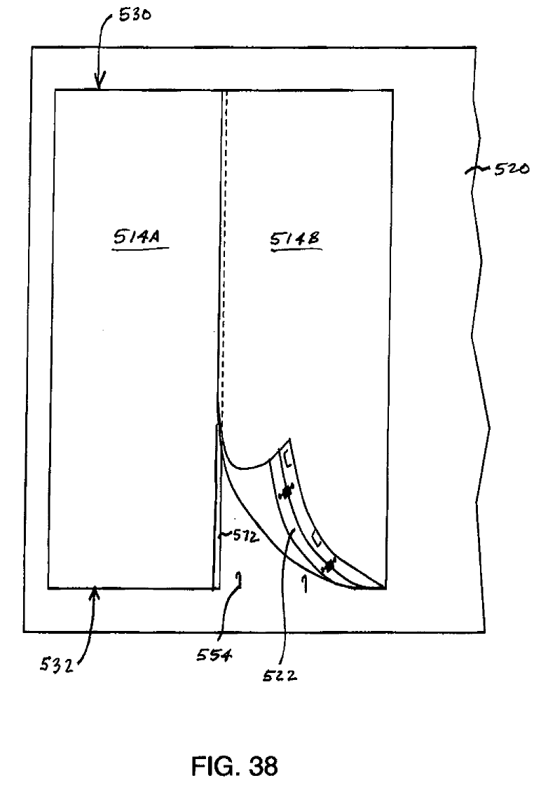

Referring now to FIGS. 37 and 38, the substrate 512 is mounted to the billboard 520 as follows. The upper edge 530 of the first panel 514A is attached to one of the upper clip assemblies 522 using the adhesive 550. A lower clip assembly 524 is attached to the first panel 514A near its lower edge 532 in a similar fashion.

A plurality of upper hooks 552 are mounted along the upper edge of the billboard, and a plurality of lower hooks 554 are mounted along the lower edge of the billboard 520. The loops 548 are placed over the upper hooks 552. The loops of the lower clip assemblies 524 (not shown) are placed over the lower hooks 554. The springs 546 are slightly stretched and tension the first panel 514A while allowing some vertical and lateral movement relative to the billboard 520. The masking plate 544 extends above the panel 514A as needed to hide the upper hooks 552 from view.

After the first panel 514A is in place, a second panel 514B may be hung using additional clip assemblies 522 and 524 as described above and is moved to the desired lateral relationship with the first panel 514A (see FIG. 13). The panels 514A and 514B may be placed edge-to-edge. Preferably, however, the panels 514A and 514B are overlapped to some degree so that any misalignment or motion from winds will not expose gaps. An example of a suitable amount of overlap is about 2.5 cm (1 in.).

If desired, means may be provided for securing the adjacent panels 514 together after they have been aligned properly. Examples of suitable materials include double-sided tape 572 applied between the panels 514, transparent tape applied over the front of the joint between the panels 514, adhesives, mechanical fasteners or the like.

Once the second panel 514B is properly aligned, its bottom edge is attached to the bottom mounts 524 in the same manner as for the first panel 514A. The attachment process is then repeated until the billboard face 518 is covered to the desired degree. If desired, the outermost left and right vertical edges of the substrate 512 may be secured to the billboard 520 using tape, adhesives, a trim panel, or the like.

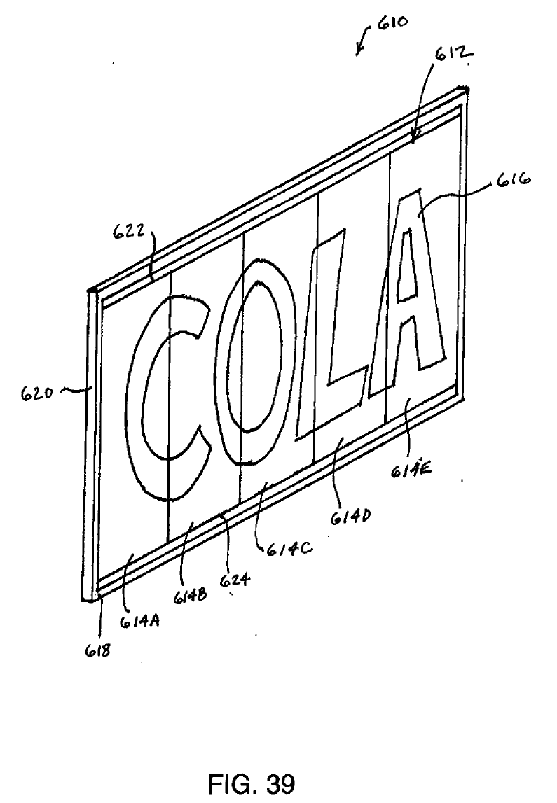

FIG. 39 illustrates yet another alternative advertising display 610 constructed according to the present invention. The advertising display 610 includes a substrate 312 made up of a plurality of panels 614A-614E carrying graphics 616. The panels 614 are attached to the face 618 of a billboard 620 by upper and lower hook assemblies 622 and 624.

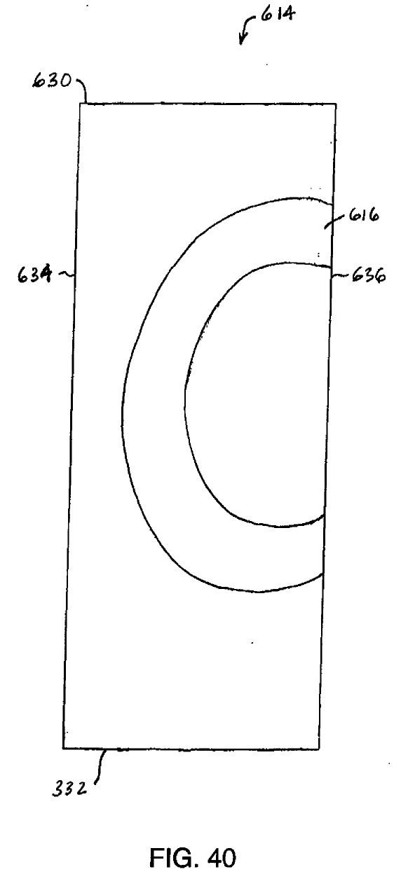

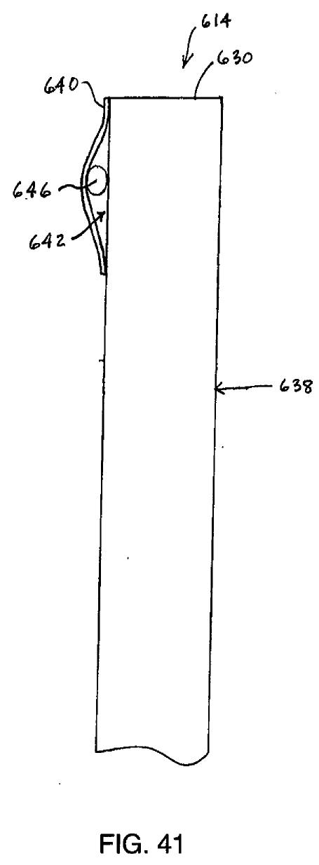

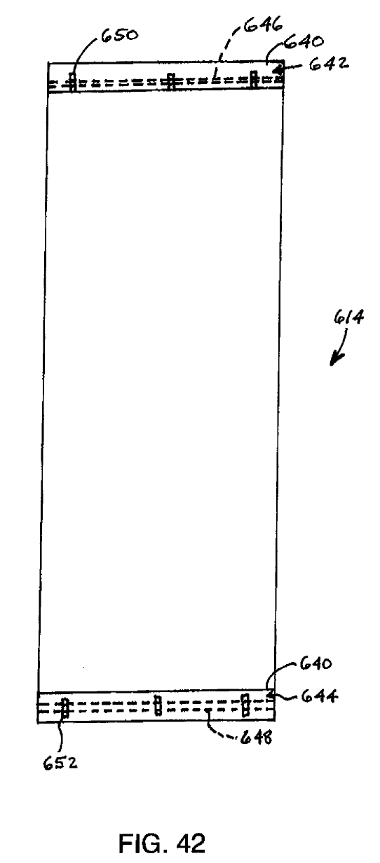

FIGS. 40, 41, and 42 illustrate an exemplary panel 614 of the substrate 612, which is representative of all of the panels 614A-614E. The panel 614 is a sheet-like member having opposed top and bottom edges 630 and 632, and left and right edges 634 and 636. A front side 638 of the panel 614 has a graphic 616 applied thereto, for example by screen printing, painting, dying, or the like. The panel 614 may be constructed from any material which can be fabricated in the desired shape and capable of carrying graphics thereon. Examples of suitable materials include paper, fiberboard, or other similar fibrous materials, fabrics, plastic, thin sheet metal, and the like. It is also possible for a single panel 614 to extend the entire width of the billboard 620.

Reinforcing strips 640 are applied to the panel 614 along its top and bottom edges 630 and 632, so as to define upper and lower pockets 642 and 644. The reinforcing strips 640 may be made of a material such as polyethylene or light metal and attached to the panel 614 with an adhesive. Substantially rigid, laterally-extending upper and lower reinforcing bars 646 and 648 are disposed in the upper and lower pockets 642 and 644, respectively. The reinforcing bars 646 and 648 may be made from a non-conductive material such as plastic. Access slots 650 and 652 are formed in the reinforcing strips 640 to provide access to the reinforcing bars 646 and 648, respectively.

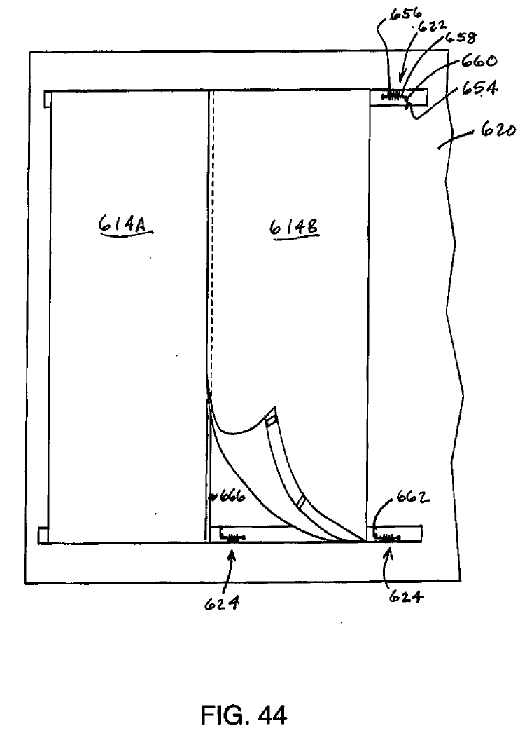

As shown in FIG. 44, a plurality of upper hook assemblies 622 are resiliently mounted to the billboard 620. In the illustrated example, each upper hook assembly 622 includes a hook 654 connected to a horizontally-oriented spring 656 by a filament 658 running over a pulley 660, to minimize the vertical extent of the upper hook assembly 622. The hook 654 is free to swing or pivot to some degree relative to the surface of the billboard 620, but produces a tension force when it is extended along a vertical axis. A plurality of these upper hook assemblies 622 are mounted in a row along the upper portion of the billboard 620 with a pattern and spacing corresponding to the number of panels 614 and their width.

A plurality of lower hook assemblies 624 having lower hooks 662 are mounted to the billboard 620. In the illustrated example, the lower hook assemblies 624 are substantially identical in construction to the upper hook assemblies 622. It is also possible that the lower hook assemblies 624 could be simple hooks without a tensioning mechanism, in which case the upper hook assemblies 622 would provide all of the tension. The reverse arrangement is also possible.

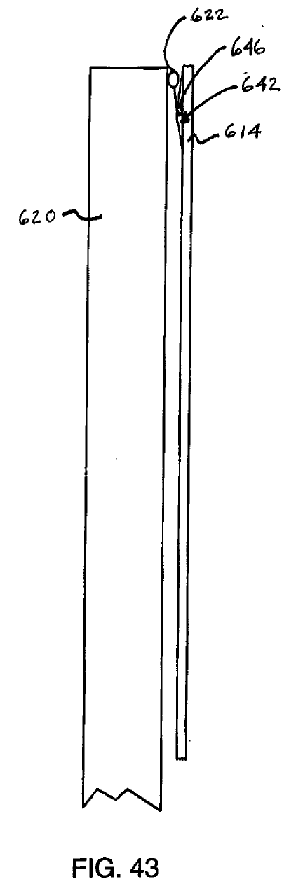

Referring to FIGS. 43 and 44, the substrate 612 is mounted to the billboard 620 by engaging the upper and lower hooks 654 and 662 through the access slots 650 and 652 and around the upper and lower reinforcing bars 646 and 648, respectively. When the hook assemblies 622 and 624 are released after engagement, they tension the first panel 614A in a vertical direction and also pull it against the billboard 620. The hook assemblies 622 and 624 thus tend to hold the panel 614A in place by friction so that the panel 614A can be moved laterally to some degree as desired for proper positioning.

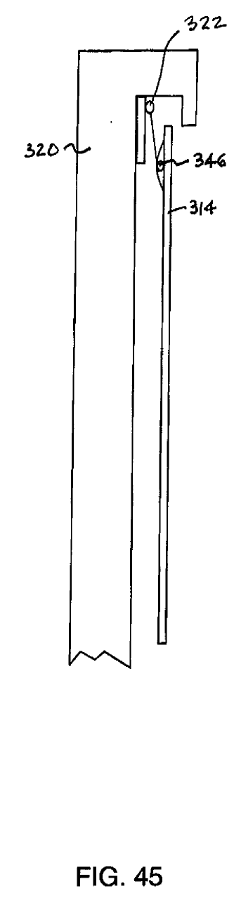

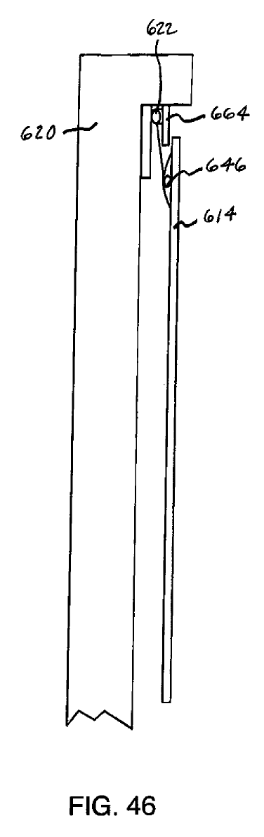

Various means may be provided for hiding the hook assemblies 622 and 624. If the billboard 620 is of a type having “overhanging” trim as shown in FIG. 45, it will naturally hide the hook assemblies 622 and 624 from view. If the billboard 620 is of a type having “flush” trim as shown in FIG. 46, then a laterally-extending masking plate 664 may be provided that covers the upper hooks 654, and a similar masking plate may be provided for the bottom of the panel 614A. It is also possible that the upper and lower reinforcing bars 646 and 648 to be mounted offset a sufficient distance from the upper and lower edges 630 and 632 respectively, so that the hook assemblies 622 and 624 are directly hidden by panel 614A itself.

After the first panel 614A is in place, a second panel 614B may be hung from the upper hook assemblies 622 as described above and is moved to the desired lateral relationship with the first panel 614A (see FIG. 39). The panels 614A and 614B may be placed edge-to-edge. Preferably, however, the panels 614A and 614B are overlapped to some degree so that any misalignment or motion from winds will not expose gaps. An example of a suitable amount of overlap is about 2.5 cm (1 in.)

If desired, means may be provided for securing the adjacent panels 614 together. Examples of suitable materials include double-sided tape 666 applied between the panels 614A and 614B, transparent tape applied over the front of the joint between the panels 614A and 614B, adhesives, mechanical fasteners or the like.

Once the second panel 614B is properly aligned, its bottom edge is attached to the bottom hook assemblies 614 in the same manner as for the first panel 614A. The attachment process is then repeated until the billboard face 618 is covered to the desired degree. If desired, the outermost left and right vertical edges of the substrate 612 may be secured to the billboard 620 using tape, adhesives, a trim panel, or the like.

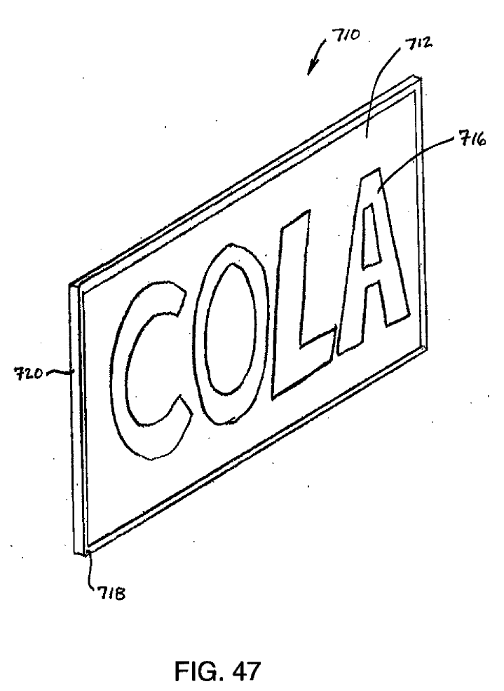

FIG. 47 illustrates another alternative advertising display 710 constructed according to the present invention. The advertising display 710 includes a substrate 712 carrying graphics 716, attached to the face 718 of a billboard 720. The illustrated substrate 712 is a single component, but it may also be made up from a plurality of connected individual panels.

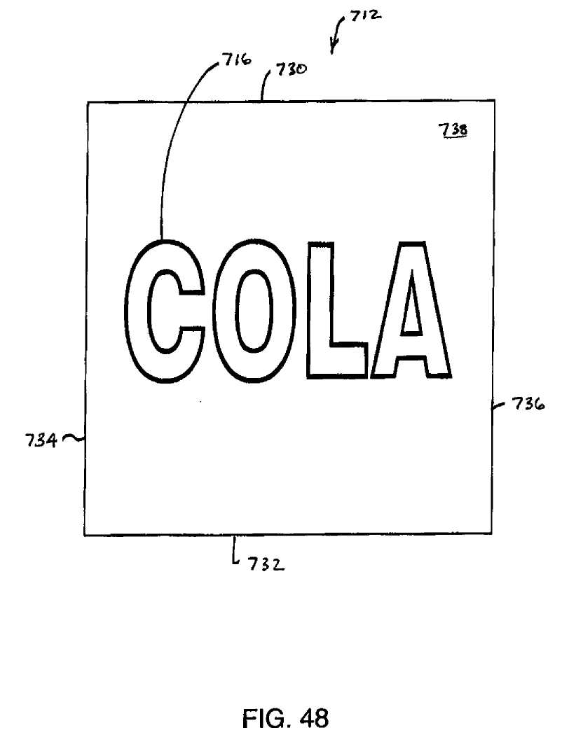

FIG. 48 illustrates an exemplary substrate 712. The substrate 714 is a sheet-like member having opposed top and bottom edges 730 and 732, and left and right edges 734 and 736. A front side 738 of the panel 714 has a graphic 716 applied thereto, for example by screen printing, painting, dying, or the like.

The substrate 712 is constructed from a material which can be fabricated in the desired shape and capable of carrying graphics thereon. More particularly, the substrate 712 comprises an elastic material. By the term “elastic” it is meant that the material exhibits recoverable deformation when stretched. Preferably, the material has a thermal expansivity small enough to avoid cracking on cold days or sagging on hot days, and also retains its elasticity on hot and cold days.

Non-limiting examples of suitable elastic materials include Polyethylene terephthalate (PET) film, and biaxially oriented polypropylene (BOPP) film. Various additives and coatings may be added or applied to the substrate 712, such as ultraviolet (UV) stabilizers, flame retardants, print receptive coatings and the like.

One suitable example of a material for the substrate 712 is a white BOPP film approximately 0.03 mm (0.009 in.) thick with a print-receptive coating applied thereto. At approximately 82° C. (180° F.) and tension of 0.19 Kg per linear cm (1 lb per linear inch), such film exhibits elongation of about 1%. At approximately 93° C. (200° F.), the elongation is about 1.5%. The shrinkage (no tension) of this film is less than about 1%. The exact amount of elongation under load and elongation with temperature is not critical so long as some tension is maintained even at high ambient temperatures (i.e. sagging does not occur) and cracking does not occur at low ambient temperatures. Tentering of the BOPP film is found to be useful in achieving the desired properties.

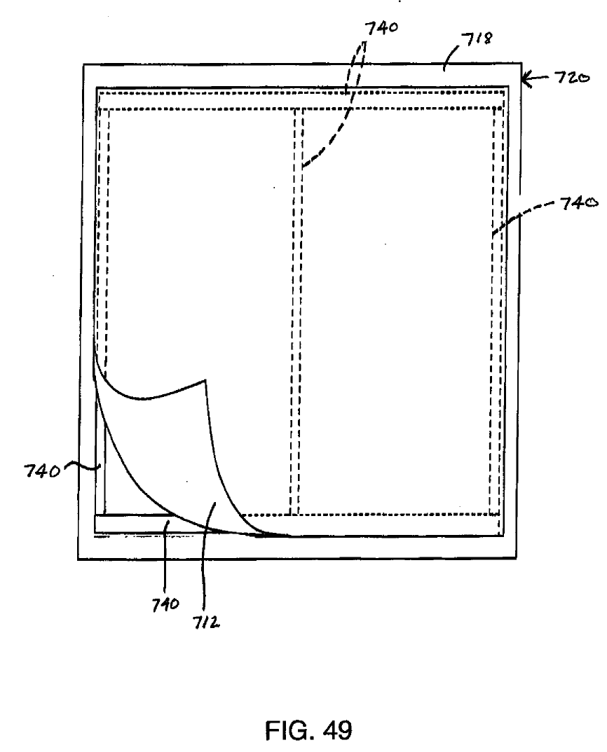

FIG. 49 illustrates the construction of the display 710 using the elastic substrate described above. A pattern of clip bars 740 is attached to the face 718 of the billboard 720, for example using the illustrated hooks 742. The clip bars 740 are relatively thin, elongated strips which may be made of a material such as polyethylene or light metal. In the illustrated example the clip bars 740 are about 2.5 cm (1 in.) wide. The clip bars 740 are disposed in a pattern generally corresponding to the outside perimeter of the substrate 712, and may include additional intermediate clip bars 740 to provide additional points of adhesion for the substrate. An adhesive such as double-sided adhesive is placed on the exposed faces of the clip bars 740.

The substrate 712, which may weigh less than about 1 Kg (2 lbs.) is simultaneously tensioned and attached to the adhesive on the clip bars 740. This may be done by pressing one edge of the substrate 712 to one of the clip bars 740 and then manually stretching the substrate 712 before attaching it to the other clip bars 740. The complete installation will have the substrate 712 adhered around all edges and tensioned on the face 718 of the billboard 720.

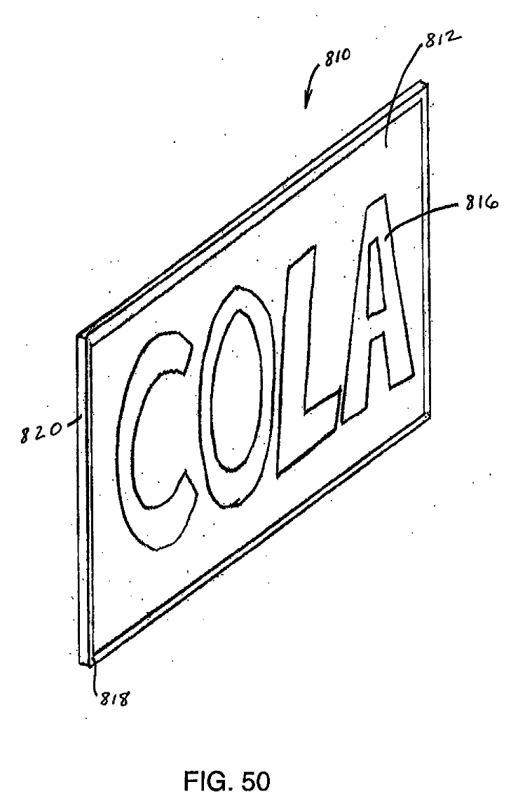

FIGS. 50-53 illustrate an alternative advertising display 810 constructed according to the present invention. The advertising display 810 is similar in construction of the display 712 described above and includes a substrate 812 carrying graphics 816, attached to the face 818 of a billboard 820. The illustrated substrate 812 is a single component, but it may also be made up from a plurality of connected individual panels.

The substrate 812 is made from an elastic material and is substantially identical to the substrate 712 described above. The substrate 812 is stretched to its working length and is held in place on a frame 818 by a suitable adhesive.

The frame 818 comprises a plurality of frame members 820 which are made of a material relatively rigid in tension and compression which will retain the tension in the substrate 812. In the illustrated example, the frame members 820 are about 1.6 mm (0.625 in.) thick and about 2.5 cm (1 in.) wide and are made of a polycarbonate material. Other relatively rigid materials may be used. As shown, the frame members 820 extending completely around the perimeter of the substrate 812, but it is also possible to provide frame members 820 only along the top and bottom or left and right sides of the substrate 812.

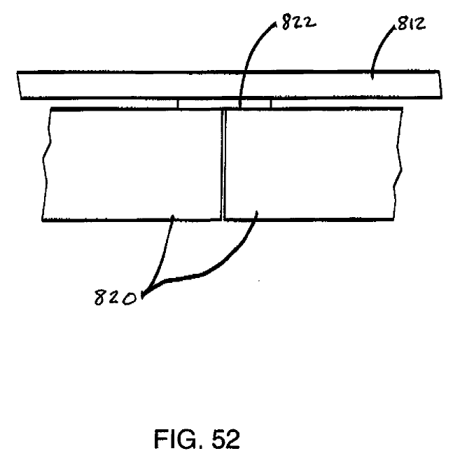

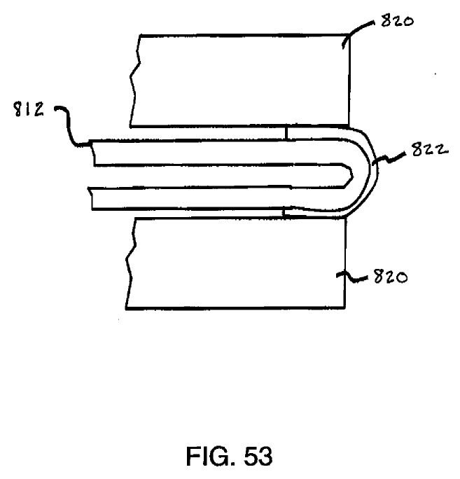

The frame members 820 are hinged together to allow folding. In the illustrated example, the hinges 822 comprise a flexible plastic film of about 0.13 mm (0.005 in.) to about 0.26 mm (0.010 in.) thickness adhered to the adjacent frame members 820. The hinge 822 allows the frame members to fold 180 degrees to lay flat on top of each other without the hinge 822 obstructing such a fold, as shown in FIGS. 52 and 53.

The top and bottom lengths of the frame 818 are hinged at the same points along their lengths and in enough places so the frame 818 can be folded to desired length for shipping and storage. The frame 818 will be folded repeatedly until all hinges 122 have been folded. Preferably, the frame 822 will be folded such that the substrate 822 is compressed at the folds rather than stretched at the folds, to avoid stretching the substrate 812 more than intended.

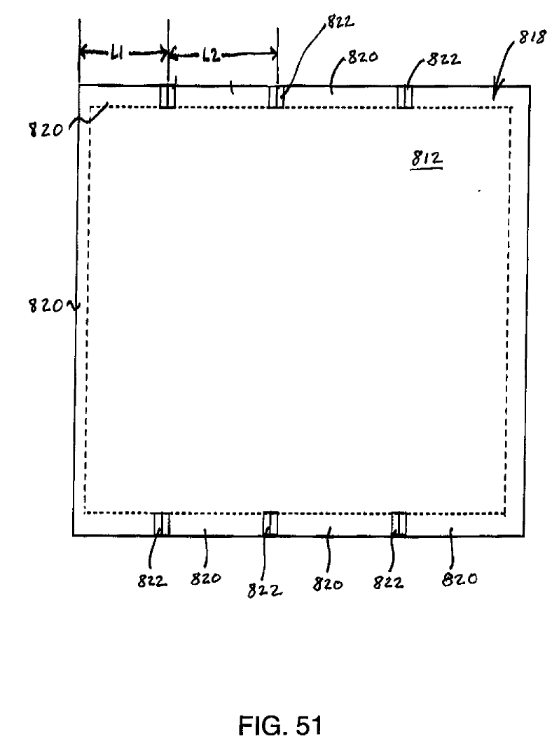

FIG. 51 shows one manner in which folding may be facilitated. The hinge points of the frame 818 are offset by a slight amount, that is, adjacent frame members 820 are not exactly the same length, but rather increase slightly in length from one frame member 820 to the next. This is best illustrated by comparing the length “L1” of a first frame member 820 to the slightly greater length “L2” of the adjacent frame member. This hinge placement enables the frame 118 to be folded over and over. The thickness of the individual hinges 822 does not become cumulative and therefore the frame 818 does not become too thick to prevent the next fold.

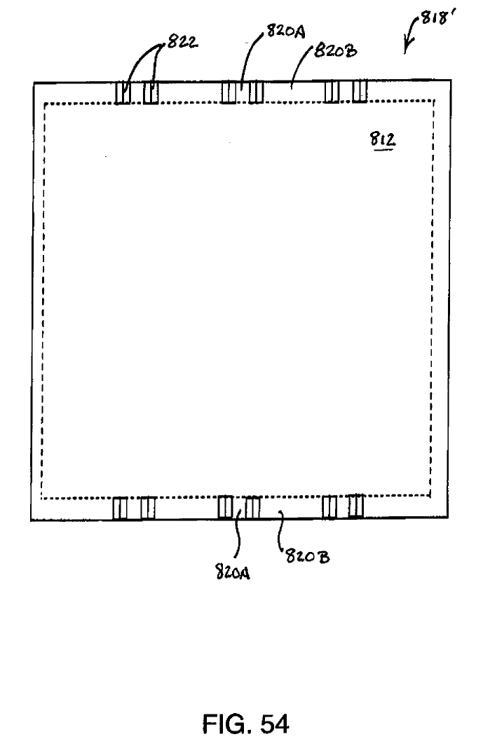

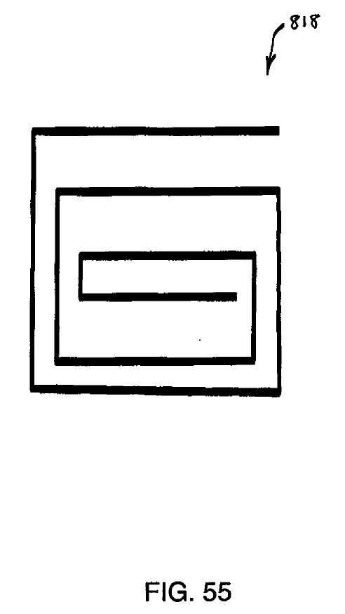

FIG. 54 shows another configuration which facilitates folding. A frame 818′ has alternating short members 820A and long members 820B connected together by hinges 822 as described above. The effect of the alternating lengths is to produce what are effectively “double” hinges at each hinge point H′ of the frame 818′. As shown in FIG. 55, this configuration permits the frame 818′ to be folded into a compact package while accommodating the increasing thickness.

When the frame 818 is unfolded, the substrate 818 remains as fully tensioned as when first attached to the frame 818. The sides of the frame 818 can also be hinged to enable top to bottom folding along with the aforementioned side to side folding.

This configuration allows the substrate 812 to be tensioned in a controlled environment (rather than directly on a billboard 820), folded and transported to the billboard 820, and then simply “hung” into place. This will reduce the on-site installation time to a great degree compared to prior art methods. The frame 818 can be completely hidden behind the substrate 812 enabling a “flush” edge to edge graphic installation.

The opened frame 818 with the attached substrate 812 can be hung on a billboard, wall, truck, etc in the same manner that the way a tensioned canvas picture can be hung on a wall. The specific fasteners and mounting hardware to be varied as needed for the specific application.

The frame 818 can also be made secure in a free-standing mode by providing latches (not shown)on the backsides of the frame 818 to secure the frame members 820 together in the unfolded configuration. The latched-together frame 818 can then be suspended from any suitable support to display the substrate 812. Non-limiting examples of applications include retail point-of-purchase (POP) signage, pole banners, set backdrops, tents, awnings, decorative boxes & cubes, and collapsible tables.

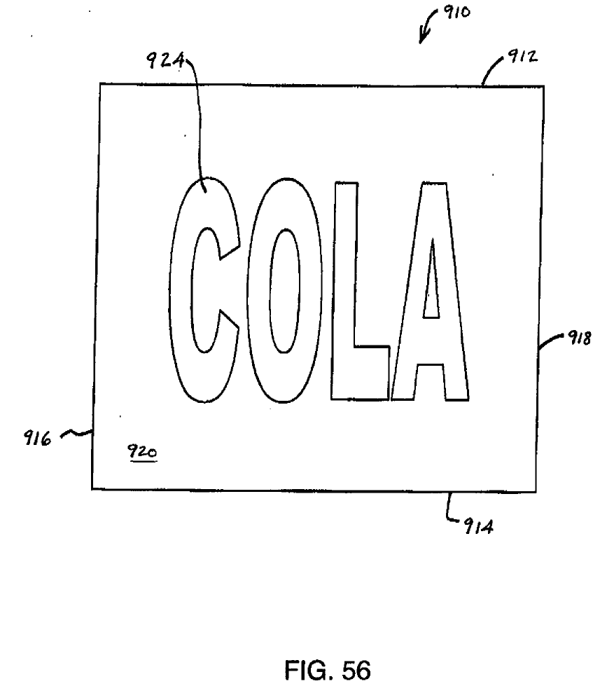

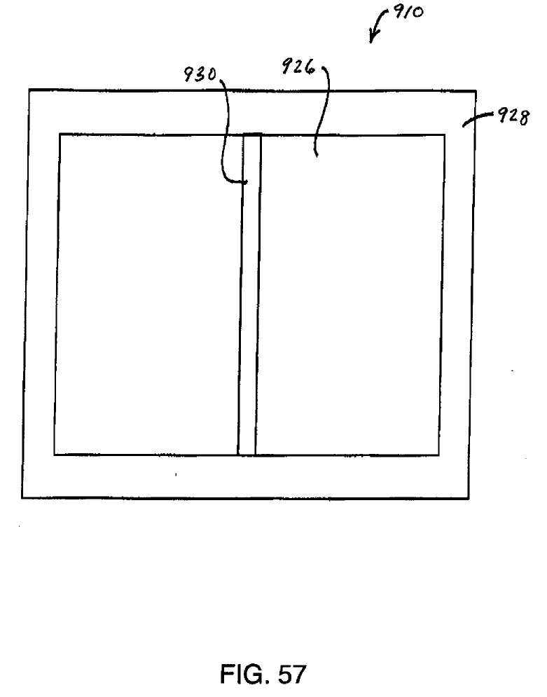

FIGS. 56 and 57 illustrate an exemplary substrate 910 for a display. The substrate 910 is a sheet-like member having opposed top and bottom edges 912 and 914, left and right edges 916 and 918, and opposed front and back faces 920 and 922. The front face 920 has a graphic 924 applied thereto, for example by screen printing, painting, dying, adhesive overlay, or the like.

The basic components of the substrate 910 are a body 926 and a perimeter reinforcement 928. The perimeter reinforcement 928 may be a single integral frame-like member as shown in FIG. 57. It may also include one or more additional interior strips or members, such as the illustrated cross-brace 930.

The dimensions of the perimeter reinforcement 928 are selected to provide adequate tensile strength, in combination with the body 926, to resist the loads incurred in mounting and displaying the substrate 910, taking into consideration the overall size of the substrate 910, tension loads from any mounting structures, expected wind loads for outdoor advertisements, and the like. The vertical and horizontal legs of the perimeter reinforcement 928 in the illustrated example are each about 2.5 cm (1 in.) wide. Their size is not of particular importance, but the total amount (area and mass) of perimeter reinforcement 928 would generally be minimized, in order to minimize the resulting material costs. In general, the larger the substrate 910, the greater the coverage of perimeter reinforcement 928. Preferably, the total area of the perimeter reinforcement 928 is limited to about 50% or less of the total area of the substrate 912. More preferably, the total area of the perimeter reinforcement 928 is about 40% or less of the total area of the substrate 910. For example, in a substrate having a width of 48 feet and a height of 14 feet, the width of the horizontal and vertical legs of the perimeter reinforcement 928 may be about 24 inches, resulting in a coverage of about 35% of the body by the perimeter reinforcement. It has been found that the incorporation of a limited amount of perimeter reinforcement 928 allows the substrate 910 to have adequate strength for outdoor use and use in tensioned mountings, while still having a weight and cost less than a unitary material having the same strength.

The body 926 may be constructed from any sheet-like material which can be fabricated in the desired shape and which is capable of carrying graphics thereon. Examples of suitable materials include paper, fiberboard, or other similar fibrous materials, fabrics, plastics, thin sheet metal, and the like. More particular examples include Polyethylene terephthalate (PET) film, and biaxially oriented polypropylene (BOPP) film. One particular example of a material for the body 912 is a white BOPP film approximately 0.03 mm (0.009 in.) thick with a print-receptive coating applied thereto. Various additives and coatings may be added or applied to the body 926, such as ultraviolet (UV) stabilizers, flame retardants, print receptive coatings and the like.

The material of the perimeter reinforcement 928 is selected in concert with its dimensions to provide adequate tensile strength as described above. Examples of suitable materials include plastic film, cloth, and the like. Generally stated, the perimeter reinforcement 928 will have a greater density and tensile strength than the body 926. More particular examples include polyester film or polypropylene film attached to the body 926.

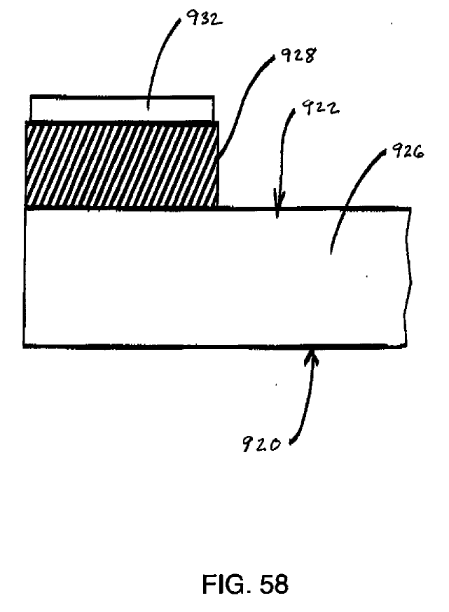

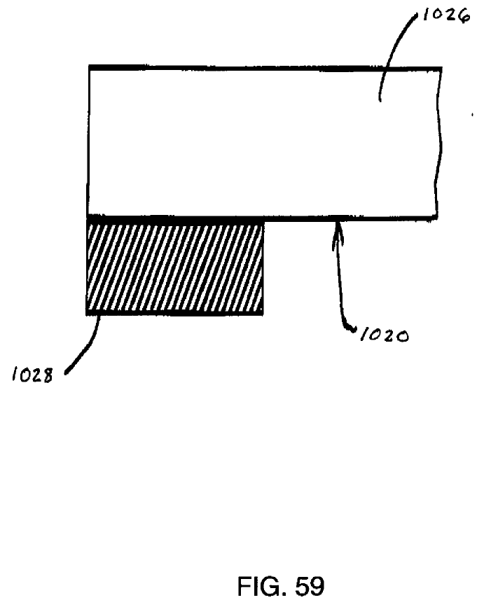

The perimeter reinforcement 928 may be incorporated in various ways. In FIG. 58, the perimeter reinforcement 928 is shown as being attached to the back face 922 of the body 926. In FIG. 59, an alternative body 1026 has a perimeter reinforcement 1028 attached to the front face 1020 thereof. Examples of suitable attachment methods include adhesives, fasteners, sewing stitches, and heat or sonic welding.

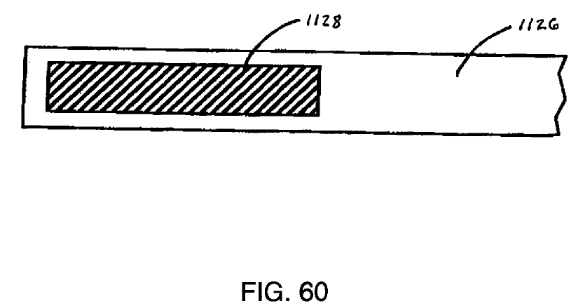

FIG. 60 illustrates another alternative body 1126 having a perimeter reinforcement 1128 molded within the perimeter edge of the body 1126.

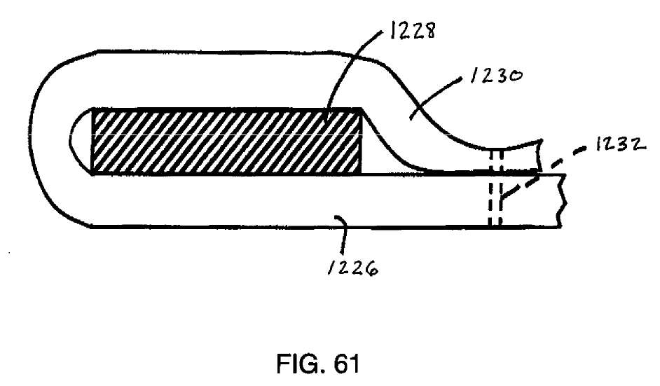

FIG. 61 illustrates another alternative body 1226 having a perimeter reinforcement 1228 secured to the body 1226 by an integral flap 1230 which is folded over and secured to the remainder of the body 1226 with a bond 1232 such as sewing stitches, a heat weld or sonic weld, adhesives, or fasteners.

The substrate described above may be used to create a number of different types of displays by simply attaching it to or suspending it from a suitable supporting structure. For example, the substrate 10 may be attached to the face of a billboard (not shown). The display may be a single large substrate 10 or it may be made up from two or more smaller sections.

In cases where the substrate 10 is to be attached to a surface, it may be provided with an adhesive for mounting. As shown in FIG. 58, an adhesive 932 may be disposed on the exposed portion of perimeter reinforcement 928. The adhesive 932 may be applied as a part of the manufacturing process of the perimeter reinforcement 928. For example, the perimeter reinforcement 928 may be produced as a double-sided tape, with one layer of adhesive for bonding to the body 926 and an opposed layer for attachment to a supporting structure.

The foregoing has described a graphics substrate and a graphics installation system. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

What is claimed is:

1. A graphics installation system, comprising:
a sheet-like substrate adapted to display graphics disposed thereon;
a supporting structure having a face for receiving the substrate; and
a pair of spaced-apart clamp assemblies engaging opposed edges of the substrate and positioning the substrate in a tensioned condition in front of the face.

2. The graphics installation system of claim 1 wherein each of the clamp assemblies includes a pair of elongated clamp bars adapted to grip an edge of the substrate therebetween; and a resilient element connecting the clamp bars to the supporting structure.

3. The graphics installation system of claim 2 wherein the clamp bars are attached to the substrate by resilient, generally U-shaped clips.

4. The graphics installation system of claim 1 wherein the clamp bars are attached to a surface of the substrate by an adhesive.

5. The graphics installation system of claim 1 wherein each of the clamp assemblies includes:
an elongated first bar adapted to be connected to an edge of the substrate;
an elongated second bar adapted to be connected to the supporting structure; and
a resilient element connecting the first and second bars.

6. A graphics installation system, comprising:
a sheet-like substrate adapted to display graphics disposed thereon;
a supporting structure having a face for receiving the substrate;
a pair of spaced-apart clamp assemblies engaging opposed edges of the substrate; and
a pair of spaced-apart cable assemblies connected to respective ones of the clamp assemblies, the cable assemblies extending substantially parallel to respective edges of the substrate and arranged so as to position the substrate in a tensioned condition in front of the face.

7. The graphics installation system of claim 6 wherein each of the cable assemblies includes a cable having a first end anchored to the supporting structure and a second end connected to a winch for tensioning the cable.

8. The graphics installation system of claim 6 wherein each of the clamp assemblies includes a pair of elongated clamp bars adapted to grip an edge of the substrate therebetween; and a resilient element connecting the clamp bars to the supporting structure.

9. The graphics installation system of claim 8 wherein the clamp bars are attached to the substrate by resilient, generally U-shaped clips.

10. A graphics installation system, comprising:
a sheet-like substrate having at least one pair of opposed edges, the substrate adapted to display graphics disposed thereon;
a pair of rigid bars carried by the substrate extending along the respective opposed edges;
a supporting structure having a face for receiving the substrate; and
a plurality of resilient mounts carried by the substrate and engaging the rigid bars so as to position the substrate in a tensioned condition in front of the face.

11. The graphics installation system of claim 10 wherein each of the rigid bars is carried in a pocket defined by a reinforcing strips applied to the substrate along an edge thereof.

12. The graphics installation system of claim 10 wherein each of the rigid bars is carried in a pocket defined by a reinforcing strips applied to the substrate along an edge thereof.

13. The graphics installation system of claim 10 wherein each of the rigid bars is carried in a pocket defined by a reinforcing strips applied to the substrate along an edge thereof.

14. A graphics installation system, comprising:
a sheet-like substrate having at least one pair of opposed edges, the substrate adapted to display graphics disposed thereon;
a pair of rigid bars carried by the substrate extending along the respective opposed edges;
a supporting structure having a face for receiving the substrate; and
a plurality of resilient mounts carried by the substrate and engaging the rigid bars so as to position the substrate in a tensioned condition in front of the face.

15. A graphics installation system, comprising:
a sheet-like substrate adapted to display graphics disposed thereon;
a perimeter frame attached to the substrate of rigid bars carried by the substrate extending along the respective opposed edges;
a supporting structure having a face for receiving the substrate; and
a plurality of resilient mounts carried by the substrate and engaging the rigid bars so as to position the substrate in a tensioned condition in front of the face.

16. A graphics installation system, comprising:
a flexible, sheet-like substrate adapted to display graphics disposed thereon; and
a frame comprising a plurality of relatively rigid elongated members attached to a face of the substrate near its perimeter, so at to retain the substrate in a substantially flat, tensioned condition.

17. The graphics installation system of claim 16 wherein adjacent ones of the frame members are connected to each other with flexible hinges so as to allow the substrate to be folded into a compact configuration.

18. The graphics installation system of claim 17 wherein the lengths of the frame members are varied such that the hinges are offset from each other in a folded configuration.

19. A graphics installation system, comprising:
a sheet-like substrate adapted to display graphics disposed thereon;
a perimeter frame attached to the substrate of rigid bars carried by the substrate extending along the respective opposed edges;
a supporting structure having a face for receiving the substrate; and
a plurality of resilient mounts carried by the substrate and engaging the rigid bars so as to position the substrate in a tensioned condition in front of the face.

20. A graphics substrate, comprising:
a sheet-like body adapted to display graphics disposed thereon; and
a reinforcement extending around a perimeter of the substrate.

21. The graphics substrate of claim 20, wherein the total area of the perimeter reinforcement is limited to about 50% or less of the total area of the body.

22. The graphics substrate of claim 20, wherein the perimeter reinforcement is attached to a face of the body.

23. The graphics substrate of claim 20, wherein the perimeter reinforcement is embedded within the body.
